(19) United States
(12) Patent Application Publication
(10) Pub. No.: US 2019/0241070 A1
(43) Pub. Date: Aug. 8, 2019

(54) DISPLAY CONTROL DEVICE AND DISPLAY CONTROL METHOD

(71) Applicant: Mitsubishi Electric Corporation, Tokyo (JP)

(72) Inventors: Shuhei OTA, Tokyo (JP); Takayoshi CHIKURI, Tokyo (JP)

(73) Assignee: Mitsubishi Electric Corporation, Tokyo (JP)

(21) Appl. No.: 16/330,026

(22) PCT Filed: Oct. 28, 2016
(86) PCT No.: PCT/JP2016/082069

§ 371 Date: Mar. 1, 2019

(51) Int. Cl. B60K 37/06; G02B 27/01; B60K 35/00; H04N 13/20

(52) U.S. Cl. CPC B60K 37/06; G02B 27/0101; B60K 2370/52; H04N 13/20; B60K 35/00

(57) ABSTRACT

A display control device includes a depth distance setting unit for setting a depth distance of a display object corresponding to display object information; a binocular parallax setting unit for setting a binocular parallax value of the display object depending on the set depth distance; a binocular parallax correcting unit for correcting the set binocular parallax value; a different display mode setting unit for changing a display mode of the display object based on a corrected amount of the binocular parallax value; and a display controller for outputting, to the display device, a stereoscopic vision image including the display object based on either the set binocular parallax value or the corrected binocular parallax value, in which the correction lowers the binocular parallax value in part of a depth distance range, and the different display mode setting unit changes a size of the display object depending on the corrected amount.

### TECHNICAL FIELD

The present invention relates to a display control device and a display control method used for a display device for a moving body.

### BACKGROUND ART

In the related art, display devices that display a left-eye image and a right-eye image and thereby enables stereoscopic vision of the images have been developed. Hereinafter, an image viewed by a user in the form of stereoscopic vision from a left-eye image and a right-eye image is referred to as a “stereoscopic image.” A distance from a position of an eye of a user or a position corresponding to the position of the eye to a position of a stereoscopic image is referred to as a “depth distance.”

In a case where parallax between a left-eye image and a right-eye image, so-called “binocular parallax,” is excessively increased in a display device for stereoscopic vision, the left-eye image and the right-eye image may be recognized as separate images, and thus the user may not be able to view the stereoscopic image in some cases. In this case, a so-called “double image” occurs, causing problems such as visual fatigue or discomfort of the user (see Non-Patent Literature 1). With regard to this problem, Patent Literatures 1 and 2 discloses techniques for preventing excessively large binocular parallax.

A stereoscopic image converter 100 of Patent Literature 1 includes an imaging condition extraction part 111 which extracts convergence angle conversion information which is an imaging condition for capturing left and right images and an image conversion part 112 which changes a convergence angle at the time when the left and right images have been captured. The image conversion part 112 includes: a convergence angle correction value calculation part which, on the basis of the convergence angle conversion information extracted by the imaging condition extraction part 111 and display size information of a display screen for displaying the left and right images, calculates the maximum parallax amount of the left and right images and calculates a convergence angle correction value which allows the calculated maximum parallax amount to be less than or equal to a previously-designated maximum parallax amount; and a convergence angle conversion processing part which generates an image by changing, on the basis of the calculated convergence angle correction value, the convergence angle at the time when the left and right images have been captured. As a result, when an image for stereoscopic vision is displayed, it is possible to display the amount of parallax in a retracting direction at a predetermined amount of parallax or less regardless of the screen size (see Summary, FIG. 1, etc. of Patent Literature 1).

A display device 100 of Patent Literature 2 includes: a parallax information acquisition unit 12 for acquiring the maximum value and the minimum value of parallax in image data on the basis of a left-eye image and a right-eye image; a depth information acquisition unit 13 for acquiring a depth amount of the image data on the basis of a difference between the acquired maximum and minimum values of the parallax; a zoom display detection unit 14 for detecting the presence or absence of zoom display on the basis of a variation in the depth amount between pieces of image data; and a correcting unit 16 for performing correction on the image data so as to mitigate a load of viewing in the case where zoom display is detected and the maximum value of the parallax is larger than or equal to a threshold value. As a result, the load of viewing of a viewer is mitigated in a stereoscopic vision image including zoom display (see Summary, FIG. 2, etc. of Patent Literature 2).

### CITATION LIST

### Patent Literatures

Patent Literature 1: JP 2012-85102 A
Patent Literature 2: JP 2015-115676 A

### Non-Patent Literature

Non-Patent Literature 1: 3D Consortium “3DC Safety Guidelines” issued Nov. 31, 2011.

### SUMMARY OF INVENTION

### Technical Problem

In a case where stereoscopic vision is implemented by a display device for a moving body such as a head-up display (HUD), a depth distance of a stereoscopic image is important. For example, in the case where the moving body is a vehicle and a navigation device that guides a travel route of the vehicle is provided, when guidance is provided on a guidance object such as an intersection located 30 meters ahead the vehicle, it is preferable that the depth distance of a stereoscopic image corresponding to the guidance object is set to approximately 30 meters. Also, when guidance is provided simultaneously on a first guidance object positioned 10 meters ahead and a second guidance object positioned 50 meters ahead, it is preferable that the depth distance of a stereoscopic image corresponding to the first guidance object is set to approximately 10 meters and that the depth distance of a stereoscopic image corresponding to the second guidance object is set to approximately 50 meters.

Here, binocular parallax between a left-eye image and a right-eye image is one of the factors for human beings to recognize the depth distance. Therefore, in the case where the binocular parallax is simply corrected in order to suppress occurrence of a double image (corresponds to changing the convergence angle in Patent Literature 1 or correction of parallax in Patent Literature 2), there is a problem that the depth distance of a stereoscopic image recognized by a user changes, thereby failing to implement a stereoscopic vision suitable for the display device for a moving body as the above.

The present invention has been devised in order to solve the above problems, and it is an object of the present invention to provide a display control device and a display control method capable of implementing a stereoscopic vision suitable for a display device for a moving body while suppressing occurrence of a double image.

### Solution to Problem

A display control device of the present invention is used for a display device for a moving body, the display control device including: a depth distance setting unit for setting a depth distance of a display object corresponding to display object information; a binocular parallax setting unit for setting a binocular parallax value of the display object depending on the depth distance set by the depth distance setting unit; a binocular parallax correcting unit for correcting the binocular parallax value set by the binocular parallax setting unit; a different display mode setting unit for changing a display mode of the display object on the basis of a corrected amount of the binocular parallax value; and a display control unit for outputting, to the display device, a stereoscopic vision image including the display object on the basis of either the binocular parallax value set by the binocular parallax setting unit or the binocular parallax value corrected by the binocular parallax correcting unit, in which the correction by the binocular parallax correcting unit lowers the binocular parallax value in at least a part of a depth distance range, and the different display mode setting unit changes at least a size of the display object depending on the corrected amount of the binocular parallax value.

A display control method of the present invention is a display control method used for a display device for a moving body, the display control method including the steps of: setting, by a depth distance setting unit, a depth distance of a display object corresponding to display object information; setting, by a binocular parallax setting unit, a binocular parallax value of the display object depending on the depth distance set by the depth distance setting unit; correcting, by a binocular parallax correcting unit, the binocular parallax value set by the binocular parallax setting unit; changing, by a different display mode setting unit, a display mode of the display object on the basis of a corrected amount of the binocular parallax value; and outputting, by a display control unit to the display device, a stereoscopic vision image including the display object on the basis of either the binocular parallax value set by the binocular parallax setting unit or the binocular parallax value corrected by the binocular parallax correcting unit, in which the correction by the binocular parallax correcting unit lowers the binocular parallax value in at least a part of a depth distance range, and the different display mode setting unit changes at least a size of the display object depending on the corrected amount of the binocular parallax value.

### Advantageous Effects of Invention

According to the present invention, due to the configuration as described above, it is possible to provide a stereoscopic vision image suitable for a display device for a moving body while occurrence of a double image is suppressed.

### BRIEF DESCRIPTION OF DRAWINGS

FIG. 1 is a functional block diagram illustrating a main part of a display control device according to a first embodiment of the present invention.

FIG. 2A is an explanatory diagram illustrating a structure of an HUD, an exemplary depth distance, and an exemplary imaging distance according to the first embodiment of the present invention.

FIG. 2B is an explanatory diagram illustrating a structure of an HUD of a windshield type.

FIG. 2C is an explanatory diagram illustrating a structure of an HUD of a combiner type.

FIG. 3 is a characteristic graph according to the first embodiment of the present invention.

FIG. 4 is an explanatory diagram illustrating an example of a virtual three-dimensional space used for generation of stereoscopic vision images according to the first embodiment of the present invention.

FIG. 5A is an explanatory diagram illustrating an example of stereoscopic vision images according to the first embodiment of the present invention. FIG. 5B is an explanatory diagram illustrating another example of a stereoscopic vision image according to the first embodiment of the present invention.

FIG. 6A is an explanatory diagram illustrating exemplary correspondence relationship among a depth distance of a display object, a binocular parallax value of the display object, and a stereoscopic vision image including the display object according to the first embodiment of the present invention. FIG. 6B is an explanatory diagram illustrating another exemplary correspondence relationship among a depth distance of a display object, a binocular parallax value of the display object, and a stereoscopic vision image including the display object according to the first embodiment of the present invention. FIG. 6C is an explanatory diagram illustrating still another exemplary correspondence relationship among a depth distance of a display object, a binocular parallax value of the display object, and a stereoscopic vision image including the display object according to the first embodiment of the present invention.

FIG. 7A is a hardware configuration diagram illustrating the main part of the display control device according to the first embodiment of the present invention, and FIG. 7B is another hardware configuration diagram illustrates the main part of the display control device according to the first embodiment of the present invention.

FIG. 8 is a flowchart illustrating the operation of the display control device according to the first embodiment of the invention.

FIG. 9 is an explanatory diagram illustrating the operation of the display control device according to the first embodiment of the present invention.

FIG. 10A is an explanatory diagram illustrating an example of a stereoscopic vision image including a comparative display object according to the first embodiment of the present invention.

FIG. 10B is an explanatory diagram illustrating another example of a stereoscopic vision image including a comparative display object according to the first embodiment of the present invention.

FIG. 11 is a functional block diagram illustrating a main part of another display control device according to the first embodiment of the present invention.

FIG. 12 is a functional block diagram illustrating a main part of still another display control device according to the first embodiment of the present invention.

FIG. 13 is a flowchart illustrating the operation of yet another display control device according to the first embodiment of the invention.

FIG. 14 is a functional block diagram illustrating a main part of a display control device according to a second embodiment of the present invention.

FIG. 15 is an explanatory diagram illustrating an example of a display area of an HUD according to the second embodiment of the present invention.

FIG. 16 is a characteristic graph according to the second embodiment of the present invention.

FIG. 17A is an explanatory diagram illustrating exemplary correspondence relationship among a depth distance of a display object, a binocular parallax value of the display object, and a stereoscopic vision image including the display object according to the second embodiment of the present invention. FIG. 17B is an explanatory diagram illustrating another exemplary correspondence relationship among a depth distance of a display object, a binocular parallax value of the display object, and a stereoscopic vision image including the display object according to the second embodiment of the present invention.

FIG. 18 is a flowchart illustrating the operation of the display control device according to the second embodiment of the present invention.

FIG. 19 is a functional block diagram illustrating a main part of another display control device according to the second embodiment of the present invention.

FIG. 20 is a flowchart illustrating the operation of the other display control device according to the second embodiment of the present invention.

FIG. 21 is an explanatory diagram illustrating a relationship between the overlooking angle and a display device.

FIG. 22 is a functional block diagram illustrating a main part of a display control device when a third embodiment is applied to the first embodiment.

FIG. 23 is a functional block diagram illustrating a main part of a display control device when the third embodiment is applied to the second embodiment.

### DESCRIPTION OF EMBODIMENTS

To describe the present invention further in detail, embodiments for carrying out the present invention will be described below with reference to the accompanying drawings.

### First Embodiment

In the first embodiment, the depth distance of a stereoscopic image is first adjusted by a binocular parallax value of the left and right eyes. However, since a double image is generated when the binocular parallax value is excessively increased, there is a limit to the range of depth distance that can be adjusted by a binocular parallax value. This limit exists on both the far side and the near side as viewed from a user. In the first embodiment, therefore, in the case where the depth distance that can be adjusted by a binocular parallax value is exceeded, the size of the stereoscopic image is further changed in addition to the adjustment with the binocular parallax value. For example, in the case where it is desired to display the stereoscopic image on the far side, the stereoscopic image is reduced for display. Conversely, in the case where it is desired to display the stereoscopic image on the near side, the stereoscopic image is enlarged for display. This relies on the fact that human beings recognize that small objects are far and that large objects are close.

This allows a stereoscopic object to appear as being displayed at a desired depth distance even when the depth distance exceeds the limit. Note that it is not necessary to perform the above adjustment on both the far side and the near side, and the adjustment may be made on only one of them.

Furthermore, human beings recognize that objects in an upper side in the forward field of view are far and that objects in a lower side are close. In the first embodiment, it is proposed that an object far from a user may be moved upward while an object located closer to the user may be moved downward in addition to the processing of changing the size as described above.

That is, in the first embodiment, within the range of depth distance that can be adjusted by a binocular parallax value, adjustment is made with the binocular parallax value. This is a technical concept that, in the case where the depth distance that can be adjusted by a binocular parallax value is exceeded, other processing for human beings to recognize the depth distance is further performed in addition to adjustment with the binocular parallax value. This other processing may be one step of processing or a combination of several steps of processing. It is not necessary to process both the far side and the near side, and the processing may be performed on either one as necessary.

Hereinafter, detailed description will be provided along with the drawings.

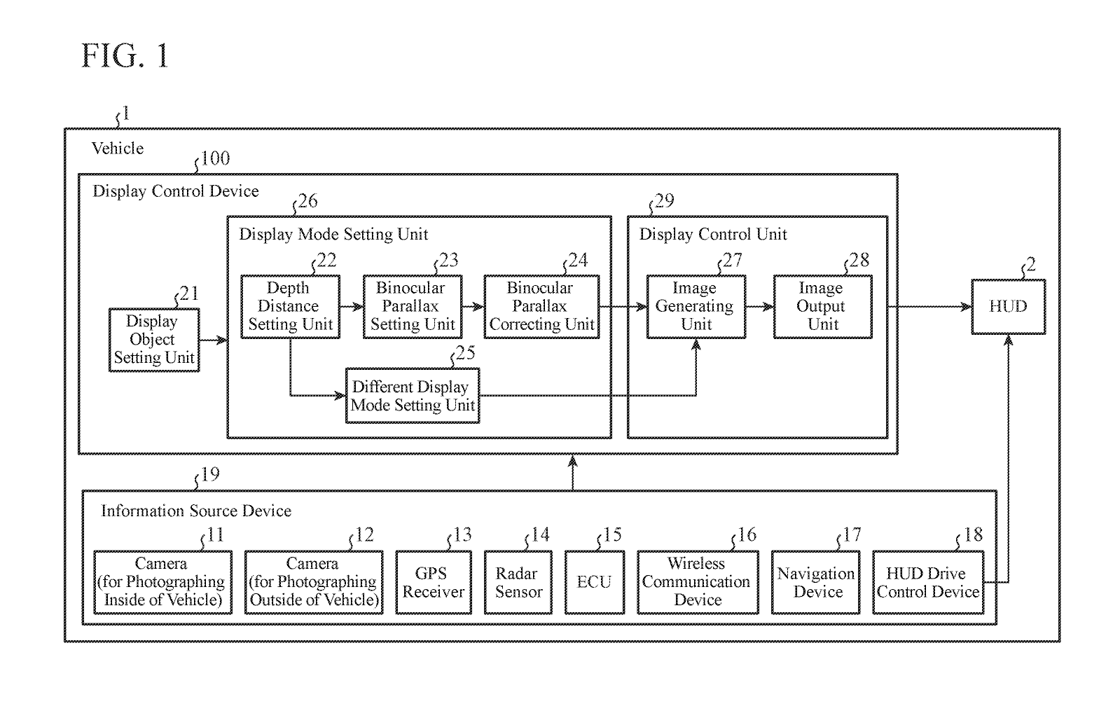

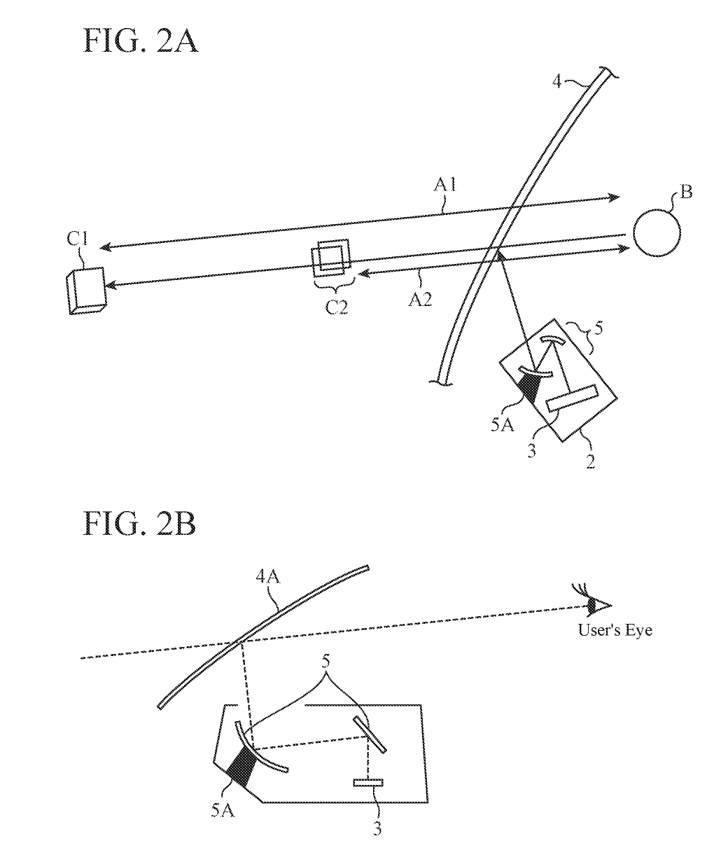

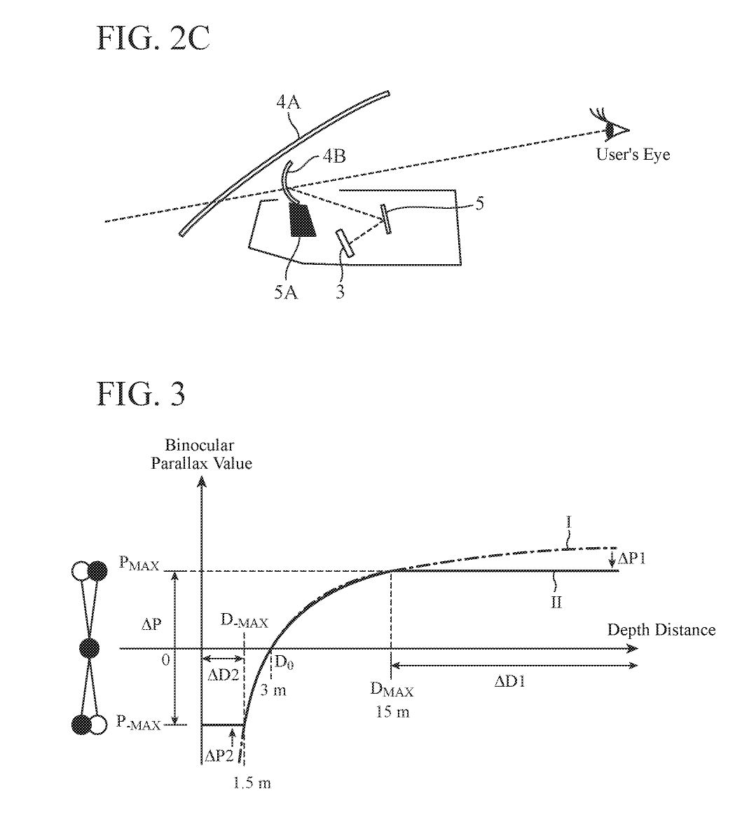

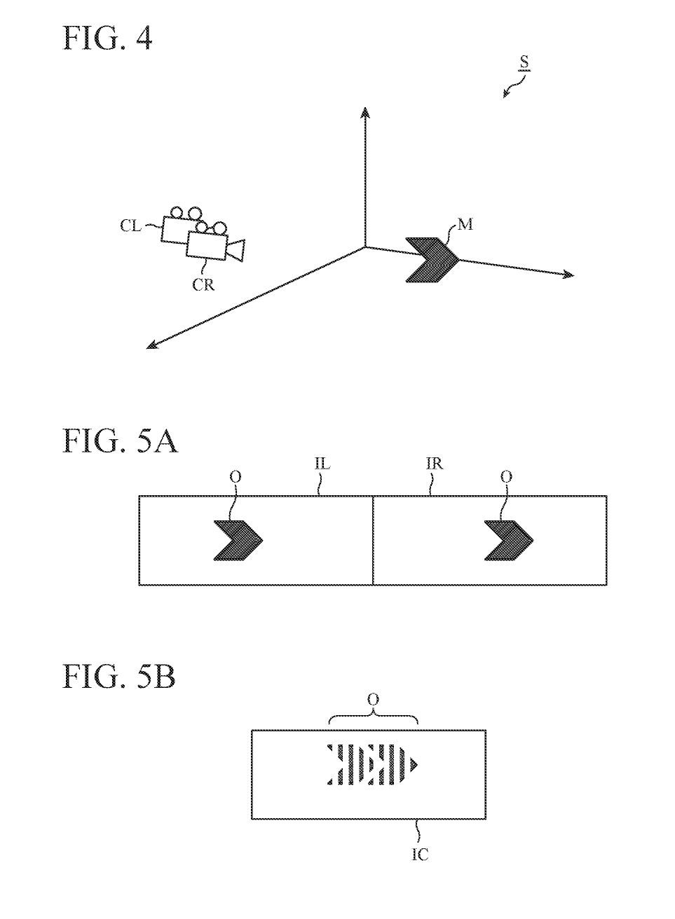

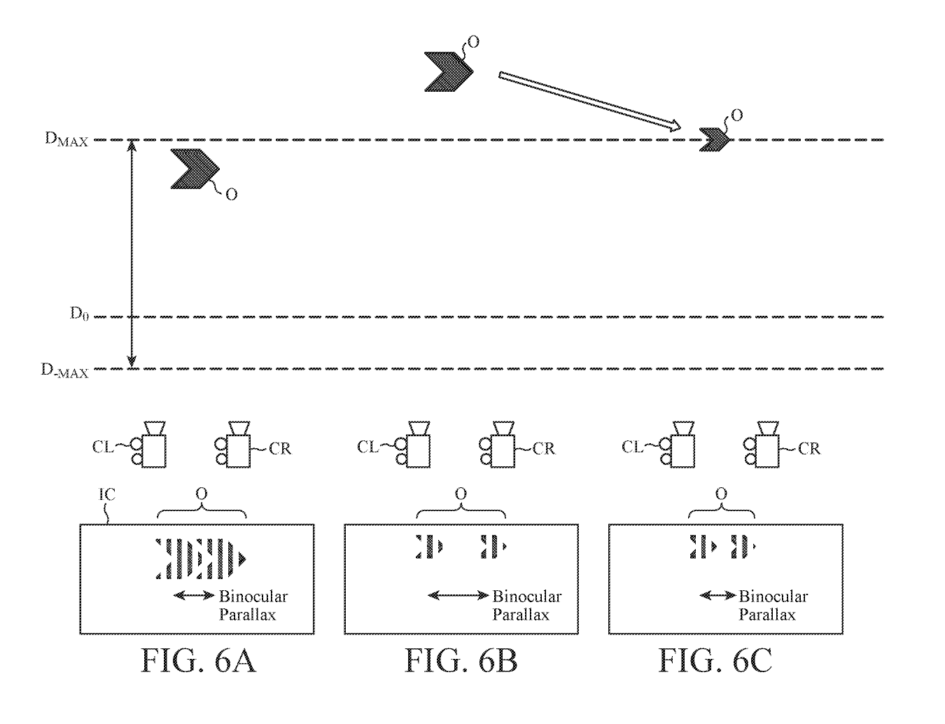

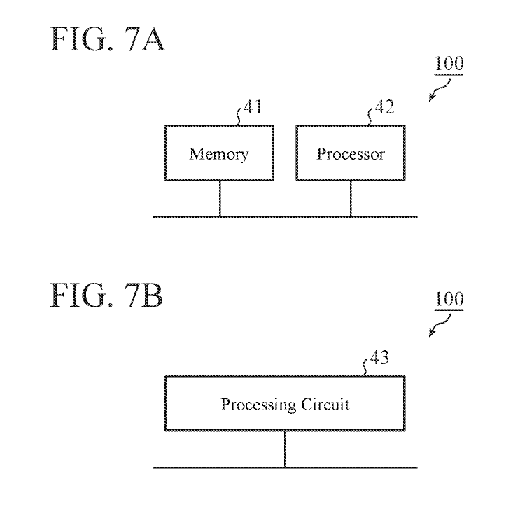

FIG. 1 is a functional block diagram illustrating a main part of a display control device according to the first embodiment of the present invention. FIG. 2A is an explanatory diagram illustrating a structure of an HUD, an exemplary depth distance, and an exemplary imaging distance according to the first embodiment of the present invention. FIG. 2B is an explanatory diagram illustrating a structure of an HUD of a windshield type, and FIG. 2C is an explanatory diagram illustrating a structure of an HUD of a combiner type. FIG. 3 is a characteristic graph illustrating a first characteristic line and more according to the first embodiment of the present invention. FIG. 4 is an explanatory diagram illustrating an example of a virtual three-dimensional space used for generation of stereoscopic vision images according to the first embodiment of the present invention. FIG. 5A is an explanatory diagram illustrating an example of stereoscopic vision images according to the first embodiment of the present invention. FIG. 5B is an explanatory diagram illustrating another example of a stereoscopic vision image according to the first embodiment of the present invention. FIG. 6A is an explanatory diagram illustrating exemplary correspondence relationship among a depth distance of a display object, a binocular parallax value of the display object, and a stereoscopic vision image including the display object according to the first embodiment of the present invention. FIG. 6B is an explanatory diagram illustrating another exemplary correspondence relationship among a depth distance of a display object, a binocular parallax value of the display object, and a stereoscopic vision image including the display object according to the first embodiment of the present invention. FIG. 6C is an explanatory diagram illustrating still another exemplary correspondence relationship among a depth distance of a display object, a binocular parallax value of the display object, and a stereoscopic vision image including the display object according to the first embodiment of the present invention. FIG. 7A is a hardware configuration diagram illustrating the main part of the display control device according to the first embodiment of the present invention, and FIG. 7B is another hardware configuration diagram illustrates the main part of the display control device according to the first embodiment of the present invention. FIG. 7B is another hardware configuration diagram illustrates the main part of the display control device according to the first embodiment of the present invention. With reference to FIGS. 1 to 7, a display control device 100 according to the first embodiment will be described with a focus on an exemplary application to a vehicle 1 including a four-wheeled vehicle.

As illustrated in FIG. 1, the vehicle 1 is provided with an HUD 2. FIG. 2A illustrates an exemplary structure of the HUD 2. In FIG. 2A, the HUD 2 has a display 3 and mirrors 5 that project an image displayed on the display 3 onto a semitransparent mirror 4. The HUD 2 roughly includes a windshield type (FIG. 2B) using a windshield 4A as the semitransparent mirror 4 and a combiner type (FIG. 2C) using a combiner 4B installed in front of a user as the semitransparent mirror 4. The display 3 includes, for example, a display such as a liquid crystal display and a display device capable of projecting an image such as a projector or a laser. The mirrors 5 include, for example, one or more reflecting mirrors, a semitransparent mirror for projection, etc. Here, at least a part of the mirrors is provided with an angle adjusting device 5A to allow the angle of the mirror to be adjusted. Note that in FIGS. 2A, 2B, and 2C, the mirrors 5 constitute an optical system.

The display 3 displays each of a left-eye image and a right-eye image or displays an image obtained by combination of the left-eye image and the right-eye image (hereinafter referred to as a “composite image”). Hereinafter, these images displayed on the display 3 are collectively referred to as “stereoscopic vision images.” That is, the HUD 2 displays stereoscopic vision images superimposed on a landscape outside the vehicle that is viewed through the semitransparent mirror 4 of the vehicle 1.

A camera 11 photographs the interior of the vehicle 1. The camera 11 outputs image information indicating the captured image to the display control device 100.

A camera 12 photographs the outside of the vehicle 1. The camera 12 outputs image information indicating the captured image to the display control device 100.

A global positioning system (GPS) receiver 13 receives GPS signals from GPS satellites (not illustrated). The GPS receiver 13 outputs position information corresponding to coordinates indicated by the GPS signals to the display control device 100.

A radar sensor 14 includes, for example, a radio wave sensor of the millimeter wave band, an ultrasonic sensor, a laser sensor, or the like. The radar sensor 14 detects the direction and shape of an object outside the vehicle 1, the distance between the vehicle 1 and the object, and other information. The radar sensor 14 outputs information indicating the detection results to the display control device 100.

An electronic control unit (ECU) 15 controls various operations of the vehicle 1. The ECU 15 is connected to the display control device 100 by a wire harness (not illustrated) or the like and is capable of communicating with the display control device 100 in accordance with the controller area network (CAN) standard. The ECU 15 outputs information related to various operations of the vehicle 1 to the display control device 100.

A wireless communication device 16 includes, for example, a dedicated receiver and transmitter mounted on the vehicle 1 or a portable communication terminal such as a smartphone brought into the vehicle 1. The wireless communication device 16 acquires various types of information from an external network such as the Internet and outputs these pieces of information to the display control device 100.

A navigation device 17 includes, for example, a dedicated vehicle-mounted information device mounted on the vehicle 1 or a portable information terminal such as a portable navigation device (PND) or a smartphone brought into the vehicle 1. The navigation device 17 searches for a travel route of the vehicle 1 by using map information stored in a storage device (not illustrated), position information acquired from the GPS receiver 13, and the like. The navigation device 17 further guides a travel route selected from the search results. In FIG. 1, connection lines of the GPS receiver 13 and other components with the navigation device 17 are not illustrated. The navigation device 17 outputs various types of information related to guidance of a travel route to the display control device 100.

An HUD drive control device 18 controls the angle of the mirrors 5 included in the optical system of the HUD 2. Note that the HUD drive control device 18 may execute image recognition processing on the image information acquired from the camera 11 and thereby detect the position of the eyes or the head of the user in the vertical direction, the lateral direction, and the front-rear direction of the vehicle 1 to control the angle of the mirrors 5 depending on the position. In FIG. 1, a connection line between the camera 11 and the HUD drive control device 18 is not illustrated.

In the first embodiment, an information source device 19 is composed of the camera 11, the camera 12, the GPS receiver 13, the radar sensor 14, the ECU 15, the wireless communication device 16, the navigation device 17, and the HUD drive control device 18.

A display object setting unit 21 sets information to be displayed by the HUD 2 (hereinafter referred to as “display object information”) out of the information acquired from the information source device 19 or the information generated using the information acquired from the information source device 19.

Specifically, for example, the display object setting unit 21 acquires, from the navigation device 17, information indicating the distance from the current position of the vehicle 1 to a next guidance target location, information indicating a left/right turning point of the vehicle 1 on a travel route to the guidance target location, information indicating the name of the next guidance target location, information indicating a destination of the vehicle 1, and other information. The display object setting unit 21 sets at least part of the acquired information as display object information.

Alternatively, for example, the display object setting unit 21 may generate information indicating a travelling speed, a steering angle, the current position, a traveling direction, etc. of the vehicle 1 by using the image information acquired from the camera 11, the image information acquired from the camera 12, the position information acquired from the GPS receiver 13, various types of information acquired from the ECU 15, various types of information acquired from the navigation device 17, etc. The display object setting unit 21 sets at least part of the generated information as display object information.

Further alternatively, for example the display object setting unit 21 may generate information indicating the presence or absence and position of other vehicles around the vehicle 1, the presence or absence and position of installed objects such as guardrails around the vehicle 1, the number of lanes on a road being traveled, the curvature of curves on the road being traveled, the position of a white line on the road being traveled, facilities near the road being traveled, etc. by using information such as the image information acquired from the camera 12, the position information acquired from the GPS receiver 13, various types of information acquired from the ECU 15, the map information acquired from the navigation device 17, the information of the detection result acquired from the radar sensor 14, and the point of interest (POI) information acquired from the wireless communication device 16. The display object setting unit 21 sets at least part of the generated information as display object information.

In addition, the display object setting unit 21 may set any information as display object information as long as the information is acquired from the information source device 19 or generated using information acquired from the information source device 19. For example, the display object setting unit 21 may set, as display object information, information indicating a traveling speed of another vehicle traveling ahead of the vehicle 1, a space between the vehicle 1 and the other vehicle, parking areas and the junctions on the expressway being traveled, etc.

Moreover, the display object setting unit 21 sets single or plural virtual stereoscopic objects or planar objects (hereinafter referred to as “display objects”) corresponding to the display object information.

Specifically, for example, it is assumed that information indicating left/right turning points of the vehicle 1 on the travel route to be guided is set as display object information. In this case, the display object setting unit 21 sets arrow-shaped stereoscopic objects indicating the direction of left/right turn as display objects.

Alternatively, for example, it is assumed that information indicating that another vehicle traveling ahead of the vehicle 1 has approached the vehicle 1 rapidly is set as display object information. In this case, the display object setting unit 21 sets, as a display object, a warning stereoscopic object displayed while superimposed at a position where the other vehicle is present as viewed from a user of the vehicle 1.

Further alternatively, for example, it is assumed that information indicating a facility ahead of the vehicle 1 is set as display object information. In this case, the display object setting unit 21 sets, as a display object, an emphasizing stereoscopic object displayed while superimposed at a position where the facility is present as viewed from the user of the vehicle 1.

Further alternatively, for example, it is assumed that information indicating a destination ahead of the vehicle 1 is set as display object information. In this case, the display object setting unit 21 sets, as a display object, an emphasizing stereoscopic object displayed while superimposed at a position where the destination is present as viewed from the user of the vehicle 1.

Other than the above, the display object setting unit 21 may set a stereoscopic object or a planar object of any shape as a display object depending on the content of the display object information.

A depth distance setting unit 22 sets the depth distance of a stereoscopic image by using the information acquired from the information source device 19 or the information generated by the display object setting unit 21. Here, the depth distance means a distance from a position of an eye of the user of the vehicle 1 or a position corresponding to the position of the eye to a position of the stereoscopic image corresponding to a display object.

At this time, the depth distance setting unit 22 detects the position of the eye of the user by executing image recognition processing on the image information acquired from the camera 11. The depth distance setting unit 22 sets the depth distance based on the detected position of the eye. Alternatively, the depth distance setting unit 22 sets a depth distance based on a predetermined position corresponding to the position of the eye of the user (for example, a position 20 cm away from the headrest of the driver's seat of the vehicle 1). Hereinafter, the position serving as a reference of the depth distance is simply referred to as a “reference position.” That is, the reference position may be based on an actually measured result, or a predetermined desired position may be used.

Specifically, for example, it is assumed that the display object setting unit 21 have set arrow-shaped stereoscopic objects indicating the direction of left/right turn as display objects. In this case, the depth distance setting unit 22 calculates the distance from the current position of the vehicle 1 to a position of the left/right turning point by using the position information of the vehicle 1 acquired from the GPS receiver 13 and information indicating the position of the left/right turning point acquired from the navigation device 17, etc. The depth distance setting unit 22 sets the calculated distance as the depth distance of the display object.

Alternatively, for example, it is assumed that a warning stereoscopic object displayed while superimposed at a position where another vehicle traveling ahead of the vehicle 1 is set as a display object. In this case, the depth distance setting unit 22 calculates a distance between the vehicle 1 and the other vehicle using information indicating the detection result by the radar sensor 14, etc. The depth distance setting unit 22 sets the calculated distance as the depth distance of the display object.

Alternatively, for example, it is assumed that an emphasizing stereoscopic object displayed while superimposed at a position where a facility ahead of the vehicle 1 is present is set as a display object. In this case, the depth distance setting unit 22 calculates a distance between the vehicle 1 and the facility by using the position information acquired from the GPS receiver 13, the POI information acquired from the wireless communication device 16, etc. The depth distance setting unit 22 sets the calculated distance as the depth distance of the display object.

Alternatively, for example, it is assumed that an emphasizing stereoscopic object displayed while superimposed at a position where a destination ahead of the vehicle 1 is present is set as a display object. In this case, the depth distance setting unit 22 calculates a distance between the vehicle 1 and the destination by using the position information of the vehicle 1 acquired from the GPS receiver 13 and information indicating the position of the destination acquired from the navigation device 17, etc. The depth distance setting unit 22 sets the calculated distance as the depth distance of the display object.

Note that, although the case where the calculated distance is set as the depth distance has been described in the above example, a value obtained on the basis of the calculated distance may be set as the depth distance.

A two-way arrow A1 illustrated in FIG. 2A indicates an exemplary depth distance from a position of an eye of a user B to a position of a stereoscopic image C1. A two-way arrow A2 illustrated in FIG. 2A indicates an exemplary distance from the position of the eye of the user B to a virtual image C2 of stereoscopic vision images projected by the HUD 2. Hereinafter, a distance from a reference position, similar to that of the depth distance, to a virtual image of stereoscopic vision images projected by the HUD 2 is referred to as an “imaging distance.”

In the example of FIG. 2A, the case where the depth distance A1 is set to a value larger than that of the imaging distance A2 is illustrated; however, the depth distance A1 may be set to a value equivalent to that of the imaging distance A2 or a value smaller than the imaging distance A2 in some cases. In the case where the depth distance A1 is set to a value larger than that of the imaging distance A2, a stereoscopic vision in the retracting direction, that is, on the far side from the user is implemented by stereoscopic vision images. On the other hand, in the case where the depth distance A1 is set to a value smaller than that of the imaging distance A2, a stereoscopic vision in the approaching direction, that is, on the near side from the user is implemented by stereoscopic vision images.

Note that, in the case where a plurality of display objects is set by the display object setting unit 21, the depth distance setting unit 22 sets the depth distance for each of the display objects.

A binocular parallax setting unit 23 sets a value of binocular parallax of a display object (hereinafter referred to as a “binocular parallax value”) depending on the depth distance set by the depth distance setting unit 22. Specifically, the binocular parallax setting unit 23 sets a binocular parallax value of a display object on the basis of a characteristic line (hereinafter referred to as the “first characteristic line”) indicating the binocular parallax value with respect to the depth distance. The first characteristic line is denoted as I in FIG. 3, and is based on general cognitive characteristics of human beings concerning the sense of depth. That is, the first characteristic line indicates characteristics having a logarithmic function shape with a binocular parallax value being equal to zero when the depth distance has a value equivalent to that of the imaging distance.

Note that, in the case where a plurality of display objects is set by the display object setting unit 21, the binocular parallax setting unit 23 sets a binocular parallax value for each of the display objects.

A binocular parallax correcting unit 24 sets a range of binocular parallax values (hereinafter referred to as a “reference range”) that can be adjusted by a binocular parallax value set by the binocular parallax setting unit 23. Hereinafter, an upper limit value on the far side within the reference range is referred to as a “far-side parallax upper limit value,” and an upper limit value on the near side within the reference range is referred to as a “near-side parallax upper limit value.”

When the binocular parallax value set by the binocular parallax setting unit 23 is a value outside the reference range, the binocular parallax correcting unit 24 corrects the binocular parallax value of the display object to a value within the reference range. Hereinafter, with reference to FIG. 3, a specific example of the correction method by the binocular parallax correcting unit 24 will be described.

In the first embodiment, the binocular parallax correcting unit 24 has a far-side parallax upper limit value P_{MAX} and a near-side parallax upper limit value P_{-MAX} with respect to the first characteristic line and corrects a binocular parallax value by limiting the binocular parallax value calculated on the basis of the first characteristic line with these upper limit values. In FIG. 3, the symbol I indicates the first characteristic line, and a symbol II indicates the binocular parallax value limited by both the far-side parallax upper limit value and the near-side parallax upper limit value. Moreover, ΔP indicates a reference range, P_{MAX} indicates the far-side parallax upper limit value, and P_{-MAX} indicates the near-side parallax upper limit value. Furthermore, D₀ indicates the depth distance when the binocular parallax value on the first characteristic line I equals to zero, D_{MAX} indicates the depth distance when the binocular parallax value on the first characteristic line I equals a value equivalent to the far-side parallax upper limit value P_{MAX}, and D_{-MAX} indicates the depth distance when the binocular parallax value on the first characteristic line I equals a value equivalent to the near-side parallax upper limit value P_{-MAX}.

In FIG. 3, ΔD1 indicates a range of depth distance (hereinafter referred to as the “first depth distance range”) in which a binocular parallax value on the first characteristic line I is larger than the far-side parallax upper limit value P_{MAX}. A symbol ΔD2 indicates a range of depth distance (hereinafter referred to as the “second depth distance range”) in which a binocular parallax value on the first characteristic line I is larger than the near-side parallax upper limit value P_{-MAX} on the negative side. Since the first characteristic line I has a logarithmic function shape, the first depth distance range ΔD1 represents a depth distance range corresponding to the far-distance area, and the second depth distance range ΔD2 represents a depth distance range corresponding to the near-distance area.

As illustrated in FIG. 3, the corrected binocular parallax value is obtained by, with respect to the first characteristic line I, allowing the binocular parallax value within the first depth distance range ΔD1 to be constant at a value equivalent to the far-side parallax upper limit value P_{MAX} and allowing the binocular parallax value within the second depth distance range ΔD2 to be constant at a value equivalent to the near-side parallax upper limit value P_{-MAX}.

That is, when the depth distance set by the depth distance setting unit 22 is within the range between D_{-MAX} and D_{MAX} (when the binocular parallax value is within the range of the reference range ΔP), the binocular parallax correcting unit 24 does nothing. On the other hand, when the depth distance set by the depth distance setting unit 22 exceeds D_{MAX} and is within the first depth distance range ΔD1, correction by the binocular parallax correcting unit 24 decreases the binocular parallax value of the display object toward P_{MAX}. As illustrated in FIG. 3, a decrease amount ΔP1 here gradually increases as the depth distance increases.

In addition, when the depth distance set by the depth distance setting unit 22 exceeds D_{-MAX} and is within the second depth distance range ΔD2, correction by the binocular parallax correcting unit 24 decreases the binocular parallax value of the display object toward P_{-MAX}. As illustrated in FIG. 3, the decrease amount ΔP2 here gradually increases as the depth distance decreases.

Here, the binocular parallax value is schematically described using a white circle and a black dot in FIG. 3. A white circle and a black dot represent a right-eye image and a left-eye image. Since a binocular parallax value is 0 at the depth distance of D₀, the white circle and the black dot overlap with each other. When the depth distance departs from here farther toward D_{MAX}, the white circle and the black dot are gradually separated in accordance with the first characteristic line. When the depth distance exceeds D_{MAX} and the white circle and the black dot are further separated from each other, the far-side parallax upper limit value is exceeded, and thus the stereoscopic image is no longer obtained. Conversely, when the depth distance approaches from the depth distance of D₀ toward D_{-MAX}, the positions of the white circle and the black dot are reversed, and the white circle and the black dot are gradually separated in accordance with the first characteristic line. Here, like on the far side, also on the near side the stereoscopic image can no longer be obtained when the near-side parallax upper limit value is exceeded.

In the case where the binocular parallax value has been corrected, the binocular parallax correcting unit 24 outputs the corrected binocular parallax value to an image generating unit 27. Alternatively in the case where the binocular parallax value is not corrected, the binocular parallax correcting unit 24 outputs the binocular parallax value set by the binocular parallax setting unit 23 to the image generating unit 27 without correction.

Note that in the case where a plurality of display objects is set by the display object setting unit 21, the binocular parallax correcting unit 24 determines necessity of correction for each of the display objects and in the case where correction is needed, corrects the binocular parallax value for each of the display objects. In this case, the binocular parallax setting unit 23 outputs the corrected binocular parallax value or the uncorrected binocular parallax value to the image generating unit 27 for each of the display objects.

A different display mode setting unit 25 sets a display mode that is different from the binocular parallax (hereinafter referred to as “different display mode”) out of display modes of the display object depending on the depth distance set by the depth distance setting unit 22. The different display mode includes, for example, the size and the position of the display object in a display area of the HUD 2 (that is, at least a partial area in the semitransparent mirror 4). This means that if the binocular parallax correcting unit 24 has corrected the binocular parallax value and the display object is displayed as it is, the display object is not displayed at a desired depth distance. Therefore, the different display mode setting unit 25 expresses as if the display object is displayed at the desired depth distance by changing the size or the position of the display object as factors influencing recognition of the depth distance. Note that, factors that influence recognition of the depth distance herein are not subjective but are based on general cognitive characteristics of human beings with respect to the sense of depth.

Specifically, for example, when the depth distance set by the depth distance setting unit 22 is great, the different display mode setting unit 25 reduces the size of the display object as compared with the size when the depth distance is small. Conversely, when the depth distance set by the depth distance setting unit 22 is small, the size of the display object is increased as compared with the size when the depth distance is great. That is, the size of a display object is one of the factors for human beings to recognize the depth distance of a stereoscopic image corresponding to the display object. The size of the display object is set on the basis of the general cognitive characteristics of human beings with respect to the sense of depth.

Here, the change in the size of the display object is set logarithmically with respect to the depth distance. This also applies to the position of the display object in the height direction, the color of the display object, the shading of the display object, the content of a text included in the display object, etc. which will be described below.

Note that the description above that the change by the different display mode setting unit 25 is logarithmically set with respect to the depth distance does not necessarily mean that the amount of change is determined on the basis of the depth distance. It suffices that changes are set consequently logarithmically with respect to the depth distance. For example, since the decrease amount ΔP1 of the binocular parallax value has a unique relationship with the depth distance, the amount of change can be determined by the different display mode setting unit 25 on the basis of ΔP1.

Furthermore for example, when the depth distance set by the depth distance setting unit 22 is great, the different display mode setting unit 25 sets the position of the display object upward in the height direction as compared to the case where the depth distance is small. Conversely, when the depth distance set by the depth distance setting unit 22 is great, the position of the display object is set downward in the height direction as compared to the case where the depth distance is great. That is, the position in the height direction of a display object is one of the factors for human beings to recognize the depth distance of a stereoscopic image corresponding to the display object. The position of the display object in the height direction is set on the basis of the general cognitive characteristics of human beings with respect to the sense of depth.

In addition, the different display mode setting unit 25 may set a different display mode other than the size and the position of the display object. For example, the different display mode setting unit 25 may set the color of the display object, the shading of the display object, the content of a text included in the display object, or the like.

For example, when the depth distance set by the depth distance setting unit 22 is great, the different display mode setting unit 25 sets the color of the display object to be lighter as compared to the case where the depth distance is small. Conversely, when the depth distance set by the depth distance setting unit 22 is small, the color of the display object is set to be deeper as compared to the case where the depth distance is great. That is, the color of the display object is one of the factors for human beings to recognize the depth distance of a stereoscopic image corresponding to the display object. The color of the display object is set on the basis of the general cognitive characteristics of human beings with respect to the sense of depth.

Furthermore, when the depth distance set by the depth distance setting unit 22 is large, the different display mode setting unit 25 sets the shadow of the display object smaller as compared to the case where the depth distance is small. Conversely, when the depth distance set by the depth distance setting unit 22 is small, the shadow of the display object is set larger as compared with the size when the depth distance is great. That is, the size of the shadow of a display object is one of the factors for human beings to recognize the depth distance of a stereoscopic image corresponding to the display object. The size of shadow of the display object is set on the basis of the general cognitive characteristics of human beings with respect to the sense of depth.

Note that, in the case where a plurality of display objects is set by the display object setting unit 21, the different display mode setting unit 25 sets a different display mode for each of the display objects.

The depth distance setting unit 22, the binocular parallax setting unit 23, the binocular parallax correcting unit 24, and the different display mode setting unit 25 form a display mode setting unit 26.

The image generating unit 27 generates a stereoscopic vision image including the display object based on the binocular parallax value input from the binocular parallax correcting unit (that is, either the binocular parallax value set by the binocular parallax setting unit 23 or the binocular parallax value corrected by the binocular parallax correcting unit 24) and on the different display mode set by the different display mode setting unit 25. Hereinafter, a specific example of a method for generating a stereoscopic vision image will be described with reference to FIGS. 4 and 5.

The image generating unit 27 has a 3D graphics engine and sets a virtual three-dimensional space S as illustrated in FIG. 4. In the three-dimensional space S, the image generating unit 27 arranges a virtual three-dimensional model M corresponding to a display object, a virtual camera CL corresponding to the left eye of a user of the vehicle 1, and a virtual camera CR corresponding to the right eye of the user of the vehicle 1. The image generating unit 27 uses an image obtained by photographing an area including the three-dimensional model M by the camera CL as a left-eye image and an image obtained by photographing an area including the three-dimensional model M by the camera CR as a right-eye image.

As illustrated in FIG. 5A, the image generating unit 27 sets each of a left-eye image IL and a right-eye image IR as a stereoscopic vision image. Alternatively, as illustrated in FIG. 5B, the image generating unit 27 sets a composite image IC of the left-eye image IL and the right-eye image IR as a stereoscopic vision image. Each of these images includes a display object O corresponding to the three-dimensional model.

Note that, in the case where a plurality of display objects is set by the display object setting unit 21, the image generating unit 27 generates a stereoscopic vision image including the plurality of display objects. Although in FIGS. 4 and 5, examples of stereoscopic vision images with two viewpoints are illustrated, the image generating unit 27 may generate a stereoscopic vision image with three or more viewpoints.

Here, with reference to FIG. 6, a correspondence relationship among a depth distance of a display object, a binocular parallax value of the display object, and a stereoscopic vision image including the display object will be described.

As illustrated in FIG. 6A, when a depth distance set by the depth distance setting unit 22 is a value between D_{-MAX} and D_{MAX} for a display object O, a binocular parallax value set by the binocular parallax setting unit 23 is within the reference range ΔP illustrated in FIG. 3. In this case, correction by the binocular parallax correcting unit 24 is unnecessary. The image generating unit 27 uses an image obtained by photographing, by the camera CL, an area including the three-dimensional model corresponding to the display object O in the virtual three-dimensional space as a left-eye image and an image obtained by photographing, by the camera CR, an area including the three-dimensional model as a right-eye image to obtain a composite image IC of the left-eye image and the right-eye image as a stereoscopic vision image. The composite image IC includes the display object O.

On the other hand, as illustrated in FIG. 6B, when the depth distance set by the depth distance setting unit 22 has a value greater than D_{MAX} for the display object O, a binocular parallax value set by the binocular parallax setting unit 23 is greater than the far-side parallax upper limit value P_{MAX} illustrated in FIG. 3. If a stereoscopic vision image is generated in the state illustrated in FIG. 6B, binocular parallax in a composite image IC becomes large, and a double image may be possibly generated.

Therefore, the binocular parallax correcting unit 24 reduces the binocular parallax value of the display object O to a value within the reference range ΔP, for example, a value equivalent to the far-side parallax upper limit value P_{MAX} as illustrated in FIG. 3. A composite image IC generated in a state illustrated in FIG. 6C has smaller binocular parallax than in the composite image IC illustrated in FIG. 6B. This can prevent occurrence of a double image. However, as illustrated in FIG. 6C, since the depth distance of the display object O corresponding to the corrected binocular parallax value has a value equivalent to D_{MAX}, the stereoscopic image is displayed in the depth distance of D_{MAX}, which is on the near side with respect to a desired depth distance. Therefore, in FIG. 6C, the size of the display object is reduced as compared to the display object O in FIG. 6B. It is desirable to further set the position of the display object O illustrated in FIG. 6C upward in the height direction.

An image output unit 28 outputs the stereoscopic vision image generated by the image generating unit 27 to the HUD 2. The HUD 2 causes the display 3 to display the stereoscopic vision image input from the image output unit 28.

The image generating unit 27 and the image output unit 28 form a display control unit 29. The display object setting unit 21, the display mode setting unit 26, and the display control unit 29 form the main part of the display control device 100.

In FIG. 7A, an exemplary hardware configuration of the main part of the display control device 100 is illustrated. As illustrated in FIG. 7A, the display control device 100 is configured by a general-purpose computer, and has a memory 41 and a processor 42. A program for causing the computer to function as the display object setting unit 21, the display mode setting unit 26, and the display control unit 29 illustrated in FIG. 1 is stored in the memory 41. By reading out and executing the program stored in the memory 41 by the processor 42, the functions of the display object setting unit 21, the display mode setting unit 26, and the display control unit 29 illustrated in FIG. 1 are implemented.

The memory 41 may be a semiconductor memory such as a random access memory (RAM), a read only memory (ROM), a flash memory, an erasable programmable read only memory (EPROM), or an electrically erasable programmable read only memory (EEPROM), a magnetic disk such as a hard disk drive (HDD), an optical disc, or an magneto optic disc. The processor 42 includes, for example, a central processing unit (CPU), a graphics processing unit (GPU), a digital signal processor (DSP), a microcontroller, a microprocessor, or the like.

In FIG. 7B, another exemplary hardware configuration of the main part of the display control device 100 is illustrated. As illustrated in FIG. 7B, the display control device 100 may be configured by a dedicated processing circuit 43. The processing circuit 43 may be, for example, an application specific integrated circuit (ASIC), a field-programmable gate array (FPGA), a system large-scale integration (LSI), or a combination thereof.

Note that functions of the display object setting unit 21, the display mode setting unit 26, and the display control unit 29 illustrated in FIG. 1 may be separately implemented by the processing circuit 43. Alternatively, the functions of the units may be collectively implemented by the processing circuit 43. Alternatively, some of the functions of the display object setting unit 21, the display mode setting unit 26, and the display control unit 29 illustrated in FIG. 1 may be implemented by the memory 41 and the processor 42 illustrated in FIG. 7A and the rest of the functions are implemented by the processing circuit 43 illustrated in FIG. 7B.

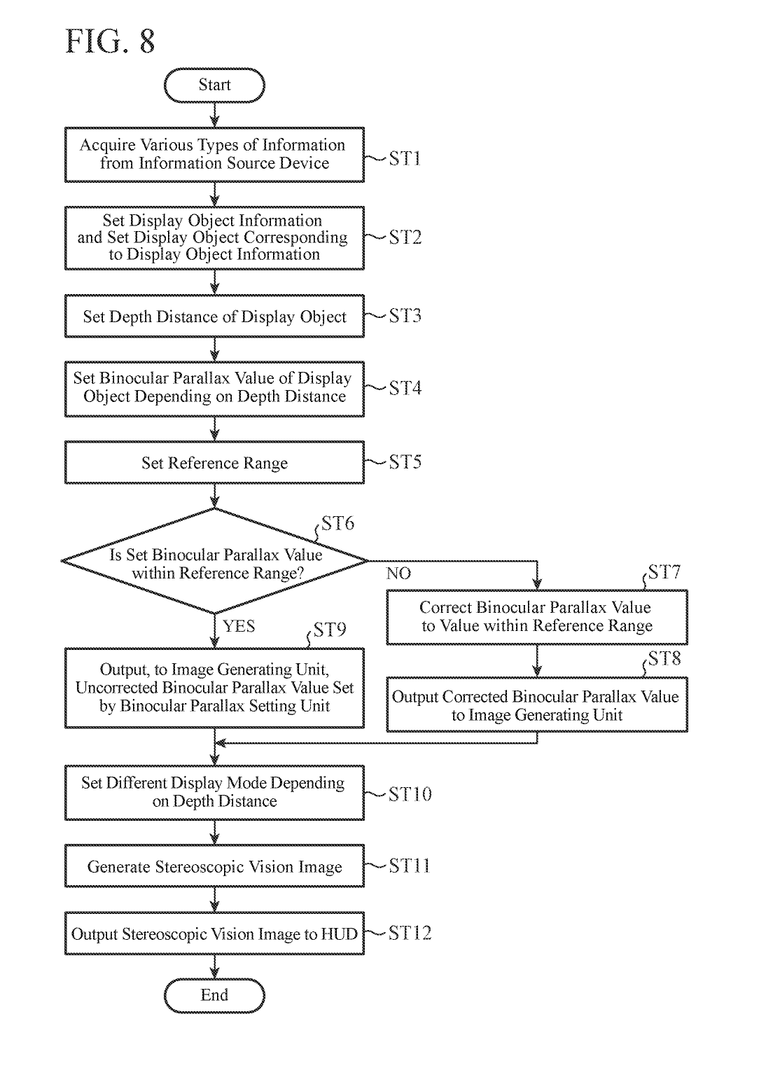

Next, with reference to the flowchart of FIG. 8, the operation of the display control device 100 will be described. The display control device 100 initializes various settings in the display control device 100 and then starts processing of step ST1.

First, in step ST1, the display object setting unit 21 acquires various types of information from the information source device 19.

Next, in step ST2, the display object setting unit 21 sets display object information from among the information acquired in step ST1 or information generated from the information acquired in step ST1. The display object setting unit 21 further sets single or plural display objects corresponding to the display object information.

Next, in step ST3, the depth distance setting unit 22 sets a depth distance of the display object set in step ST2. Note that, in the case where a plurality of display objects is set in step ST2, the depth distance setting unit 22 sets a depth distance for each of the display objects.

Next, in step ST4, the binocular parallax setting unit 23 sets a binocular parallax value of the display object depending on the depth distance set in step ST3. That is, the binocular parallax setting unit 23 sets the binocular parallax value of the display object on the basis of the first characteristic line I having a logarithmic function shape illustrated in FIG. 3. Note that, in the case where a plurality of display objects is set in step ST2, the binocular parallax setting unit 23 sets a binocular parallax value for each of the display objects.

Next, in step ST5, the binocular parallax correcting unit 24 sets the reference range ΔP. Next, in step ST6, the binocular parallax correcting unit 24 determines whether the binocular parallax value set in step ST4 is a value within the reference range ΔP set in step ST5.

If the binocular parallax value is outside the reference range ΔP (step ST6 “NO”), a double image might be generated. Therefore, in step ST7, the binocular parallax correcting unit 24 corrects the binocular parallax value of the display object to a value within the reference range ΔP. Specifically, for example, the binocular parallax correcting unit 24 corrects the binocular parallax value of the display object on the basis of the far-side parallax upper limit value or the near-side parallax upper limit value illustrated in FIG. 3. That is, if the binocular parallax value set in step ST4 is larger than the far-side parallax upper limit value P_{MAX}, the binocular parallax correcting unit 24 corrects the binocular parallax value of the display object to a value equivalent to the far-side parallax upper limit value P_{MAX}. If the binocular parallax value set in step ST4 is larger than the near-side parallax upper limit value P_{-MAX} on the negative side, the binocular parallax correcting unit 24 corrects the binocular parallax value of the display object to a value equivalent to the near-side parallax upper limit value P_{-MAX}. In step ST8, the binocular parallax correcting unit 24 outputs the binocular parallax value corrected in step ST7 to the image generating unit 27.

On the other hand, if the binocular parallax value is within the reference range ΔP (“YES” in step ST6), there is no possibility of occurrence of a double image, and thus in step ST9 the binocular parallax correcting unit 24 outputs the binocular parallax value set in step ST4 to the image generating unit 27 without correction.

Note that, in the case where a plurality of display objects is set in step ST2, the binocular parallax setting unit 23 determines whether correction is required for each of the display objects (step ST6). The binocular parallax setting unit 23 outputs a corrected binocular parallax value or an uncorrected binocular parallax value to the image generating unit 27 for each of the display objects (step ST8 or step ST9).

Next, in step ST10, the different display mode setting unit 25 sets a different display mode of the display object depending on the depth distance set in step ST3. In other words, at least one of the factors that affect recognition of the depth distance of the display object, for example the size of the display object, is set depending on the set depth distance. Here, the factors that affect the recognition of the depth distance include the size, the position in the height direction, the color, the shading, etc. of the display object. If the binocular parallax value is within the reference range ΔP (step ST6 “YES”), it is not necessary to change the different display mode of the display object. Note that, in the case where a plurality of display objects is set in step ST2, the different display mode setting unit 25 sets a different display mode for each of the display objects.

Next, in step ST11, the image generating unit 27 generates a stereoscopic vision image including the display object based on the binocular parallax value input from the binocular parallax correcting unit 24 in step ST8 or step ST9 (that is, the binocular parallax value set in step ST4 or the binocular parallax value corrected in step ST7) and on the different display mode set in step ST10. Note that, in the case where a plurality of display objects is set in step ST2, the image generating unit 27 generates a stereoscopic vision image including the plurality of display objects.

Next, in step ST12, the image output unit 28 outputs the stereoscopic vision image generated in step ST11 to the HUD 2. By the processing of step ST12, the HUD 2 causes the display 3 to display the stereoscopic vision image input from the image output unit 28.

After step ST12, the display control device 100 determines whether to end the display of the stereoscopic vision image. Specifically, the display control device 100 determines to terminate the display of the stereoscopic vision image and ends the processing for example when the function of the display control device 100 is turned off by an operation input to an operation input device (not illustrated), when the engine of the vehicle 1 is turned off, or when guidance of display object information corresponding to all the display objects included in the stereoscopic vision image becomes unnecessary. In other cases, the display control device 100 determines to continue displaying the stereoscopic vision image and starts the processing of step ST1 again.

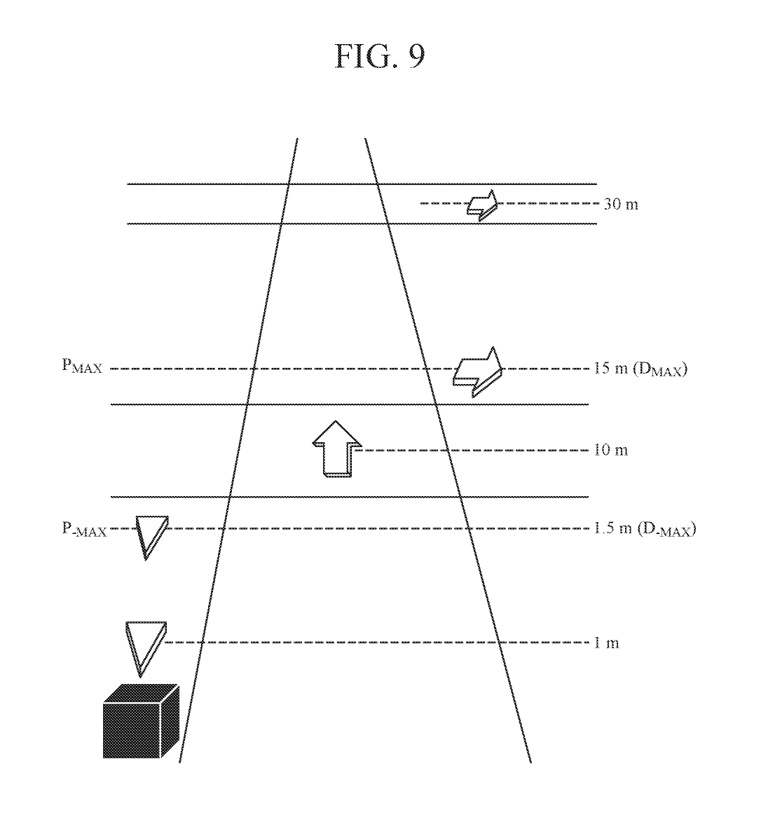

Next, a specific example of the operation of the display control device 100 will be described on the basis of the flowchart of FIG. 8 and the explanatory diagram of FIG. 9.

In step ST2, the display object setting unit 21 sets information indicating a left/right turning point of the vehicle 1 on a travel route to be guided as display object information. The display object setting unit 21 further sets an arrow-shaped stereoscopic object indicating the direction of left/right turn at that point as a display object.

In step ST3, the depth distance setting unit 22 calculates that a distance from the current position of the vehicle 1 to a position of the left/right turning point is 30 meters by using the position information acquired from the GPS receiver 13 and information indicating the position of the left/right turning point acquired from the navigation device 17, etc. The depth distance setting unit 22 sets the depth distance of the display object to a value of 30 meters.

In step ST4, the binocular parallax setting unit 23 sets a binocular parallax value when the depth distance is 30 meters on the first characteristic line I as the binocular parallax value of the display object.

In step ST5, the binocular parallax correcting unit 24 sets the reference range ΔP. Here, for example, the far-side parallax upper limit value P_{MAX} is set to a value equivalent to the binocular parallax value when the depth distance on the first characteristic line I is 15 meters (D_{MAX}).

In step ST6, the binocular parallax correcting unit 24 determines whether the binocular parallax value set in step ST4 is within the reference range ΔP. Here, the binocular parallax correcting unit 24 determines that the binocular parallax value set in step ST4 (binocular parallax value when the depth distance is 30 meters on the first characteristic line I) is larger than the parallax upper limit value P_{MAX} (binocular parallax value when the depth distance is 15 meters on the first characteristic line I), that is, a value out of the reference range ΔP (step ST6 “NO”).

In step ST7, the binocular parallax correcting unit 24 corrects the binocular parallax value of the display object to a value equivalent to the far-side parallax upper limit value P_{MAX} on the basis of the far-side parallax upper limit value. In step ST8, the binocular parallax correcting unit 24 outputs the binocular parallax value corrected in step ST7 to the image generating unit 27.

In step ST10, the different display mode setting unit 25 sets the size of the display object to be small and the position of the display object upward in the height direction depending on the depth distance (30 meters) set in step ST3. In addition, the different display mode setting unit 25 sets colors, shading, and the like of the display object.

In step ST11, the image generating unit 27 generates a stereoscopic vision image including the display object based on the binocular parallax value corrected in step ST7 and on the different display mode set in step ST10. In step ST12, the image output unit 28 outputs the stereoscopic vision image generated in step ST11 to the HUD 2.

In the above, the case where the depth distance of the display object is farther than D_{MAX} has been described. Conversely, when the depth distance of the display object is shorter than 1.5 meters (D_{-MAX}), the binocular parallax value is corrected to the near-side binocular parallax value P_{-MAX}. Then, the different display mode setting unit 25 sets the size of the display object to be increased and the position of the display object downward in the height direction depending on the depth distance (one meter) set in step ST3. In addition, the different display mode setting unit 25 sets colors, shading, and the like of the display object.

In the case where the depth distance of the display object is 10 meters and the binocular parallax value is within the reference range ΔP, the binocular parallax correcting unit 24 outputs the binocular parallax value set by the binocular parallax setting unit 23 as it is, and the different display mode setting unit 25 does not change any different display mode of the display object nor add a special display mode to the display object.

Next, the effect of the display control device 100 will be described. First, when the binocular parallax value of the display object set depending on the depth distance is outside the reference range ΔP, the display control device 100 corrects the binocular parallax value of the display object to a value within the reference range ΔP. This can suppress generation of a double image like in the techniques of Patent Literatures 1 and 2. As a result, it can be prevented that a double image interferes with the operation of the vehicle 1.

Here, generally in recognition of the sense of depth by human beings, a binocular parallax is important in an area where a value of the depth distance is small, that is, from the near-distance area to the mid-distance area. On the other hand, in an area where a value of the depth distance is great, that is, in the far-distance area, the importance of binocular parallax is low, and the size and the position in the height direction, and the like are important. That is, when the depth distance is set on the far side with respect to the D_{MAX}, it is more effective to adjust the size or the position in the height direction of the display object than to adjust the binocular parallax value.

Meanwhile, in the correction of a binocular parallax value by the display control device 100, the binocular parallax value is reduced in the first depth distance range ΔD1 corresponding to the far-distance area, and a decrease amount ΔP1 here gradually increases as the depth distance increases. As a result, the influence of the correction of the binocular parallax value on the recognition of the sense of depth by the user can be reduced while occurrence of a double image is suppressed as described above.

Moreover, the display control device 100 corrects a binocular parallax value of a display object, and different display modes such as the size or the position in the height direction of the display object are set depending on the depth distance. As a result, even when a limit is set for a binocular parallax value in order to suppress occurrence of a double image as described above, the influence of the correction of the binocular parallax value on the recognition of the sense of depth by the user can be reduced. For example, the user can be caused to visually recognize a display object, related to a guidance object such as an intersection located 30 meters ahead of the vehicle 1, as if a depth distance to the stereoscopic image is about 30 meters while generation of a double image is prevented by correction of the binocular parallax value. As a result, stereoscopic vision suitable for a vehicle-mounted display device such as the HUD 2 can be implemented.

Furthermore, when a plurality of display objects is set, the display control device 100 sets a depth distance for each of the display objects, sets a binocular parallax value for each of the display objects, corrects the binocular parallax value as required for each of the display objects, and generates a stereoscopic vision image including the plurality of display objects. As a result, for example in the case where a display object related to a first guidance object 10 meters ahead of the vehicle 1 and a display object related to a second guidance object 30 meters ahead of the vehicle 1 are simultaneously displayed, the user can be caused to visually recognize that a depth distance to a stereoscopic image corresponding to the first guidance object is about 10 meters while also caused to visually recognize that a depth distance to a stereoscopic image corresponding to the second guidance object is about 30 meters. As a result, stereoscopic vision suitable for a vehicle-mounted display device such as the HUD 2 can be implemented.

Note that as a modification of the first embodiment, the image generating unit 27 may generate a stereoscopic vision image including, in addition to the display object for which the binocular parallax value and the different display mode are set by the display mode setting unit 26, other stereoscopic objects or planar objects which can be compared to the display object (hereinafter referred to as “comparative display objects”). Here, a comparative display object expresses the depth distance of the display object. Examples of comparative display object includes one that expresses the depth distance by allowing the density to increase more in a farther side, one that expresses the depth distance by changing the size of a shadow, and one that overlays a display object on a near side viewed from the user over another display object on a far side and hides a part thereof (that is, a display object at a near side casts a shadow over another display object behind it). For example, a comparative display object is generated by the different display mode setting unit 25 and output to the image generating unit 27.

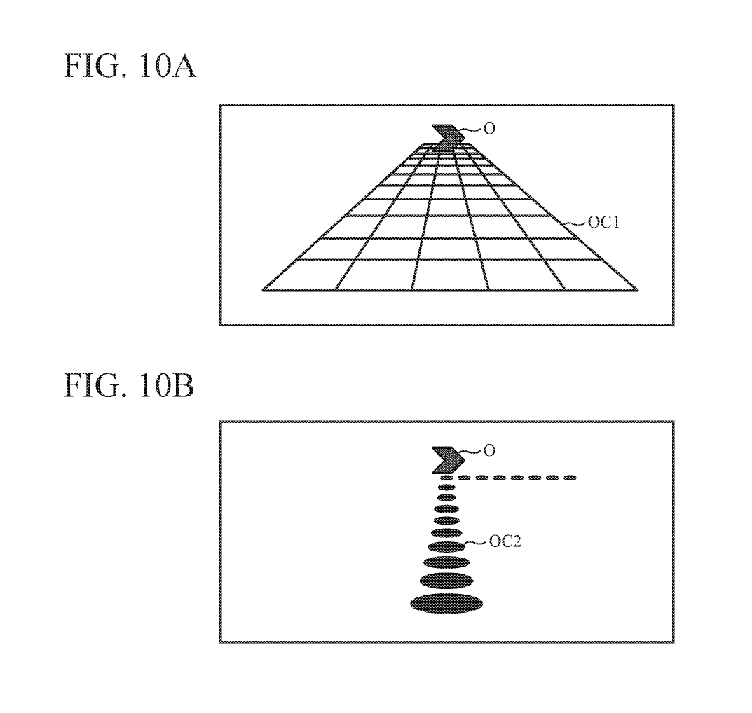

In FIG. 10, examples of a stereoscopic vision image including a comparative display object are illustrated. FIG. 10A is a diagram illustrating a stereoscopic vision image including an arrow-shaped display object O and a comparative display object OC1 of a grid-shaped perspective lines. FIG. 10B is a graph illustrating a stereoscopic vision image including an arrow-shaped display object O and a dotted line-shaped comparative display object OC2 along a travel route to be guided. By appropriately setting the positional relationship between the display object O and each of the comparative display objects OC1 and OC2 as illustrated in FIG. 10, the influence of the correction of the binocular parallax value on the recognition of the sense of depth by the user can be further mitigated. That is, this can suppress deviation of the depth distance of the stereoscopic image viewed by the user from the depth distance set by the depth distance setting unit 22.

Moreover, as already described above, the reference range ΔP may be set to a range including all the values less than or equal to the parallax upper limit value P_{MAX} without the near-side parallax upper limit value P_{-MAX} being set. That is, the binocular parallax correcting unit 24 may not execute correction to limit the binocular parallax value by P_{-MAX} in stereoscopic vision in the approaching direction but execute only the correction to limit the binocular parallax value by P_{MAX} in stereoscopic vision in the retracting direction.

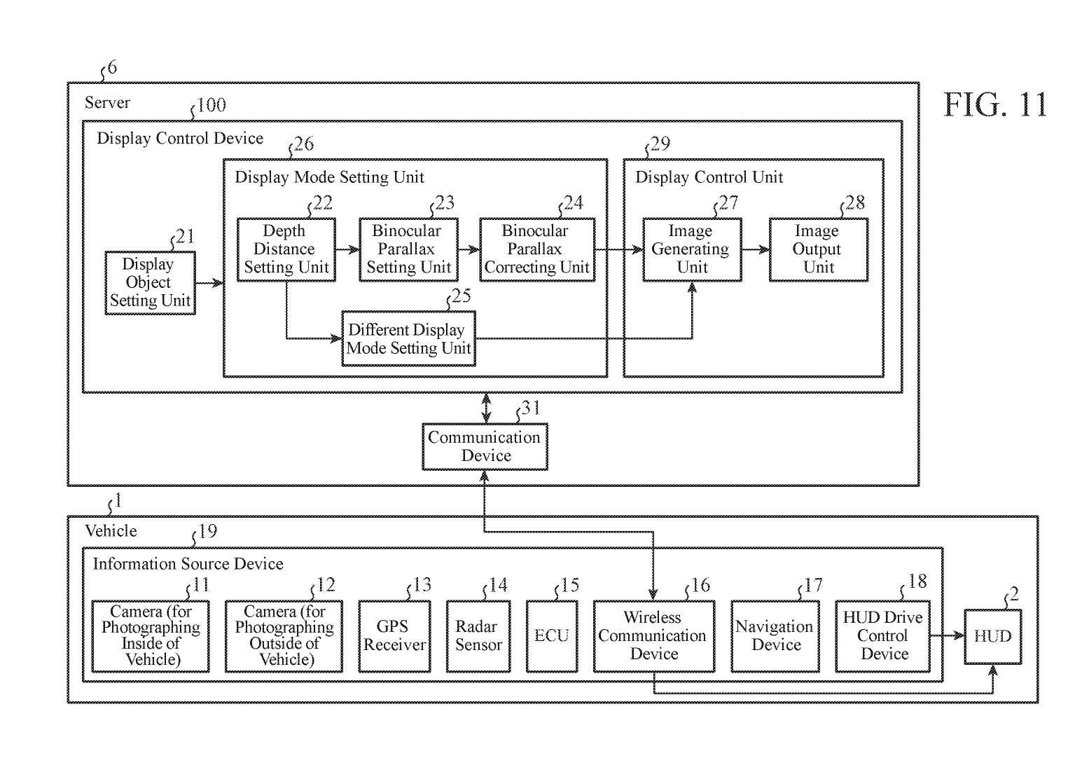

In addition, although the example in which the display control device 100 is included in the vehicle 1 has been illustrated in FIG. 1, as another modification of the first embodiment, the display control device 100 may be provided externally to the vehicle 1. An example of a functional block diagram in this case is illustrated in FIG. 11. As illustrated in FIG. 11, a display control device 100 is included in a server 6 outside a vehicle 1. The display control device 100 is capable of communicating with a wireless communication device 16 provided in the vehicle 1 by using a communication device 31 provided in the server 6.

The wireless communication device 16 transmits various types of information acquired from a camera 11, a camera 12, a GPS receiver 13, a radar sensor 14, an ECU 15, a navigation device 17, and an HUD drive control device 18 to the communication device 31. The communication device 31 outputs the information received from the wireless communication device 16 and information acquired from an external network such as the Internet to the display control device 100. The display control device 100 is configured to execute each of the above processing by using the information input from the communication device 31. Note that in FIG. 11, connection lines between each of the camera 11, the camera 12, the GPS receiver 13, the radar sensor 14, the ECU 15, the navigation device 17, and the HUD drive control device 18 and the wireless communication device 16 are not illustrated.

An image output unit 28 outputs a stereoscopic vision image generated by an image generating unit 27 to the communication device 31. The communication device 31 transmits the stereoscopic vision image to the wireless communication device 16. The wireless communication device 16 outputs the received stereoscopic vision image to an HUD 2.

Alternatively, it may be such that some of the functional blocks of the display control device 100 are provided in the vehicle 1, and the remaining functional blocks are provided in the server 6. Specifically, for example, a display object setting unit 21 and a display mode setting unit 26 may be provided in the server 6, and a display control unit 29 is provided in the vehicle 1. In this case, appropriate transmission and reception of various types of information by the wireless communication device 16 and the communication device 31 allow the above-described processing by the display control device 100 to be implemented.

Furthermore, each of the functional blocks of the display control device 100 may be implemented by any computer or any processing circuit as long as the computer or the processing circuit is mounted on the vehicle 1, brought into the vehicle 1, or capable of freely communicating with the vehicle 1. For example, some or all of the functional blocks of the display control device 100 may be provided in the wireless communication device 16 configured by a PND, a smartphone, or the like.

Alternatively, the vehicle 1 may have a head mounted display (HMD) mounted on the head of a user of the vehicle 1 instead of the HUD 2. In this case, the HMD displays an image corresponding to a landscape viewed from the user and displays a stereoscopic vision image superimposed on the image of the landscape.

Furthermore, the display control device 100 can also be used for a moving body different from the vehicle 1. For example, the display control device 100 may be provided in a portable information terminal possessed by a pedestrian to cause an HMD mounted on the head of the pedestrian to display a stereoscopic vision image.

In addition, the display control device 100 can be used for any moving body including a motorcycle, a bicycle, a railway vehicle, an aircraft, a ship, and the like. Moreover, a display device to be controlled by the display control device 100 may be any display device as long as the display device displays a stereoscopic vision image superimposed on a landscape viewed from a moving body or on an image corresponding to the landscape and is not limited to an HUD or an HMD.

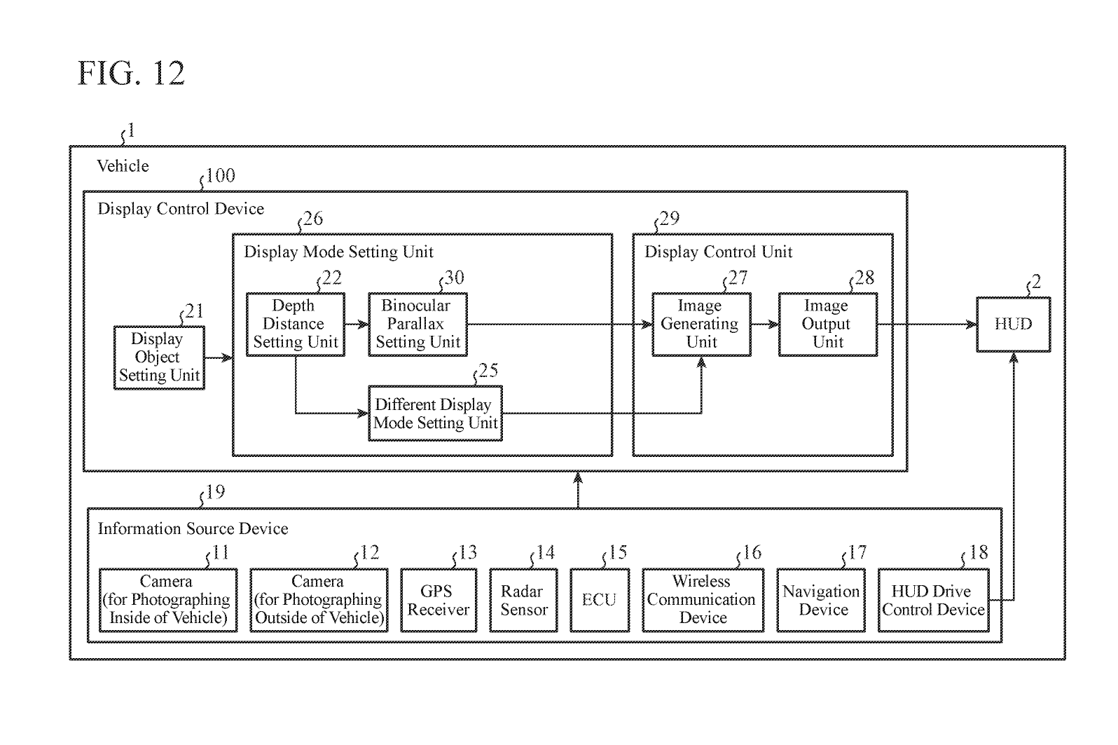

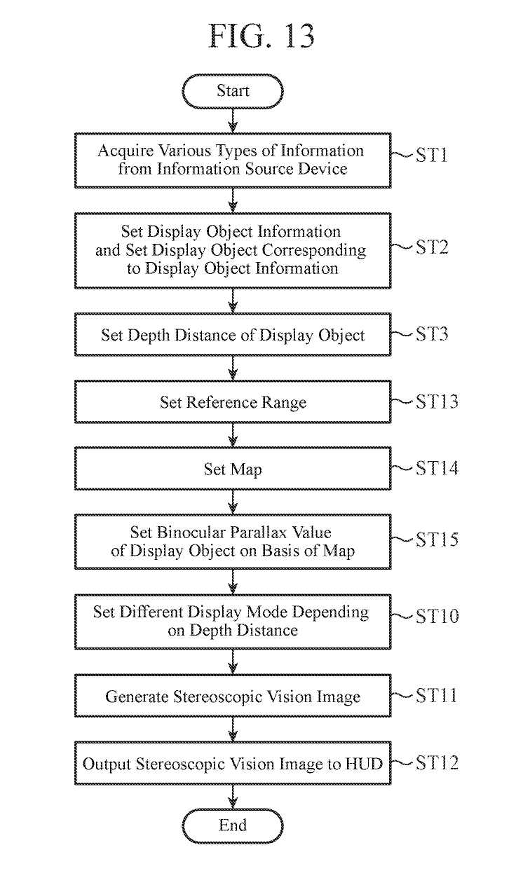

Furthermore, when setting a binocular parallax value of a display object, the display mode setting unit 26 may set the binocular parallax value by one-step processing instead of setting the binocular parallax value by the two-step processing in which a binocular parallax value is set on the basis of the first characteristic line I and then the binocular parallax value is corrected on the basis of at least one of the far-side parallax upper limit value and the near-side parallax upper limit value. This is equivalent to integration of the function of the binocular parallax setting unit and the function of the binocular parallax correcting unit. A functional block diagram in this case is illustrated in FIG. 12, and a flowchart is illustrated in FIG. 13.

Subsequent to the setting of the depth distance by a depth distance setting unit 22 (step ST3), in step ST13, a binocular parallax setting unit 30 sets a reference range similar to the reference range ΔP illustrated in FIG. 3. Next, in step ST14, the binocular parallax setting unit 30 sets a binocular parallax value obtained by limiting the first characteristic line illustrated in FIG. 3 by at least one of the far-side parallax upper limit value and the near-side parallax upper limit value. This can be set by a map or the like defining the binocular parallax value with respect to the depth distance. Next in step ST15, the binocular parallax setting unit 30 sets a binocular parallax value of the display object based on the map. Determining the depth distance by using the map in this manner allows the binocular parallax value to be set in the one-step processing. This map constitutes the binocular parallax setting unit and the binocular parallax correcting unit.

Then in step ST10, the different display mode setting unit 25 sets a different display mode of the display object based on the set binocular parallax value.

Thereafter in step ST11, an image generating unit 27 generates a stereoscopic vision image including the display object based on the binocular parallax value set in step ST15 and on the different display mode set in step ST10.

As described above, the display control device 100 according to the first embodiment is for a display device for a moving body, the display control device 100 including: the depth distance setting unit 22 for setting a depth distance of a display object corresponding to display object information; the binocular parallax setting unit 23 for setting a binocular parallax value of the display object depending on the depth distance set by the depth distance setting unit 22; the binocular parallax correcting unit 24 for correcting the binocular parallax value set by the binocular parallax setting unit 23; the different display mode setting unit 25 for changing a display mode of the display object on the basis of the corrected amount of the binocular parallax value; and the display control unit 29 for outputting, to the display device 2, a stereoscopic vision image including the display object on the basis of either the binocular parallax value set by the binocular parallax setting unit 23 or the binocular parallax value corrected by the binocular parallax correcting unit 24, in which the correction by the binocular parallax correcting unit 24 lowers the binocular parallax value in at least a part of a depth distance range, and the different display mode setting unit 25 changes at least a size of the display object depending on the corrected amount of the binocular parallax value. Therefore, the display control device 100 can generate a stereoscopic vision image suitable for a display device for a moving body while suppressing occurrence of a double image.

Moreover, the stereoscopic vision image includes a plurality of display objects, the depth distance setting unit 22 sets a depth distance for each of the display objects, the binocular parallax setting unit 23 sets the binocular parallax value for each of the display objects, the binocular parallax correcting unit 24 corrects the binocular parallax value for each of the display objects, and the different display mode setting unit 25 changes at least the size of each of the display objects depending on the corrected amount of the binocular parallax value of each of the display objects. Therefore, even when there are a plurality of display objects, the stereoscopic vision image can be separately generated.

Furthermore, the binocular parallax correcting unit 24 corrects the binocular parallax value such that an amount of decrease ΔP1 in the binocular parallax value increases as the depth distance is farther, and the different display mode setting unit 25 reduces the size of the display object in the case where the corrected amount ΔP1 is large, as compared with the case where the corrected amount ΔP1 is small. Therefore, the stereoscopic vision image for displaying the stereoscopic image of the display object at a desired depth distance can be provided while occurrence of a double image in the first depth distance range ΔD1 is suppressed.

Furthermore, the different display mode setting unit 25 moves the display object upward with respect to a front landscape or lighten a color of the display object in the case where the corrected amount ΔP1 of the binocular parallax value is large, as compared with the case where the corrected amount ΔP1 is small. Therefore, it is possible to provide the stereoscopic vision image for displaying the stereoscopic image of the display object at a desired depth distance in the first depth distance range ΔD1.

Furthermore, the binocular parallax correcting unit 24 corrects the binocular parallax value such that the amount of decrease in the binocular parallax value increases as the depth distance is closer to the near side, and the different display mode setting unit 25 increases the size of the display object more in the case where the corrected amount ΔP2 is large than in the case where the corrected amount ΔP2 is small. Therefore, the stereoscopic vision image for displaying the stereoscopic image of the display object at a desired depth distance can be provided while occurrence of a double image in the second depth distance range ΔD2 is suppressed.

Furthermore, the different display mode setting unit 25 moves the display object downward with respect to the front landscape or deepen a color of the display object in the case where the corrected amount ΔP2 of the binocular parallax value is large, as compared with the case where the corrected amount ΔP2 is small. Therefore, the stereoscopic vision image for displaying the stereoscopic image of the display object at a desired depth distance can be provided while occurrence of a double image in the second depth distance range ΔD2 is suppressed.

Furthermore, the different display mode setting unit 25 generates a comparative display object which is displayed together with the display object and expresses the depth distance of the display object. As a result, a stereoscopic vision image can be provided that allows the depth distances of the display object to be recognized through comparison.

In addition, the comparative display object includes a 3D image and expresses at least one of density, a shadow, and overlap. In other words, the comparative display object is converted into a three-dimensional object on the basis of the binocular parallax value. That is, for example, a comparative display object which is sparse on the near side and dense on the far side, a comparative display object including a shadow which becomes larger on the near side and becomes smaller on the far side, or in the case where there is a plurality of display objects, comparative display objects obtained by hiding a display object on the far side by a display object on the near side or partially losing an overlapping part of the display object on the far side are displayed in conjunction. As a result, a stereoscopic vision image can be provided that allows the depth distances of the display object to be recognized through comparison.

The binocular parallax setting unit 23 calculates the binocular parallax value of the display object on the basis of the first characteristic line I in which a binocular parallax value increases as the value moves away from the position (D₀) where the binocular parallax value equals zero, and the binocular parallax correcting unit 24 corrects the binocular parallax value by setting the upper limit P_{MAX} at least on the far side of the first characteristic line I. As a result, occurrence of a double image at the first depth distance ΔD1 can be suppressed.

Furthermore, the binocular parallax correcting unit 24 corrects the binocular parallax value by setting the upper limit P_{-MAX} on the near side of the first characteristic line I. As a result, occurrence of a double image at the second depth distance ΔD2 can be suppressed.

Furthermore, the display control unit 29 outputs the stereoscopic vision image to the display device so as to be superimposed on a landscape viewed from the moving body. As a result, a stereoscopic vision image suitable for a display device for a moving body can be provided.

Moreover, the moving body is the vehicle 1, and the display device includes the head up display 2 mounted on the vehicle 1 or a head mounted display mounted on the head of the user of the vehicle. The display control device 100 is capable of providing a stereoscopic vision image suitable for a vehicle-mounted display device.

Alternatively, the moving body is a pedestrian, and the display device includes a head mounted display mounted on the head of the pedestrian. The display control device 100 is capable of providing a stereoscopic vision image suitable for a display device for pedestrians.

The display control method according to the first embodiment is used for a display device for a moving body, the display control method including the steps of: setting, by the depth distance setting unit 22, a depth distance of a display object corresponding to display object information; setting, by the binocular parallax setting unit 23, a binocular parallax value of the display object depending on the depth distance set by the depth distance setting unit 22; correcting, by the binocular parallax correcting unit 24, the binocular parallax value set by the binocular parallax setting unit 23; changing, by the different display mode setting unit 25, a display mode of the display object on the basis of the corrected amount of the binocular parallax value; and outputting, by the display control unit 29 to the display device, a stereoscopic vision image including the display object on the basis of either the binocular parallax value set by the binocular parallax setting unit 23 or the binocular parallax value corrected by the binocular parallax correcting unit 24, in which the correction by the binocular parallax correcting unit 24 lowers the binocular parallax value in at least a part of a depth distance range, and the different display mode setting unit 25 changes at least a size of the display object depending on the corrected amount of the binocular parallax value. Therefore, a stereoscopic vision image suitable for a display device for a moving body can be generated while occurrence of a double image is suppressed.

### Second Embodiment

In the first embodiment, the example in which the binocular parallax value obtained on the basis of the first characteristic line is limited by at least one of the far-side parallax upper limit value and the near-side parallax upper limit value has been described.

Meanwhile in a second embodiment, as illustrated in FIG. 16, a binocular parallax value is obtained on the basis of a second characteristic line in which the binocular parallax value approaches the far-side parallax upper limit value P_{MAX} as the depth distance extends farther. In the second embodiment, setting of a display area of an HUD is also described. Note that a display area of the HUD can be set also in the first embodiment. Conversely, although the case of setting a display area of the HUD is described in the second embodiment, the display area of the HUD may not be set in the second embodiment.

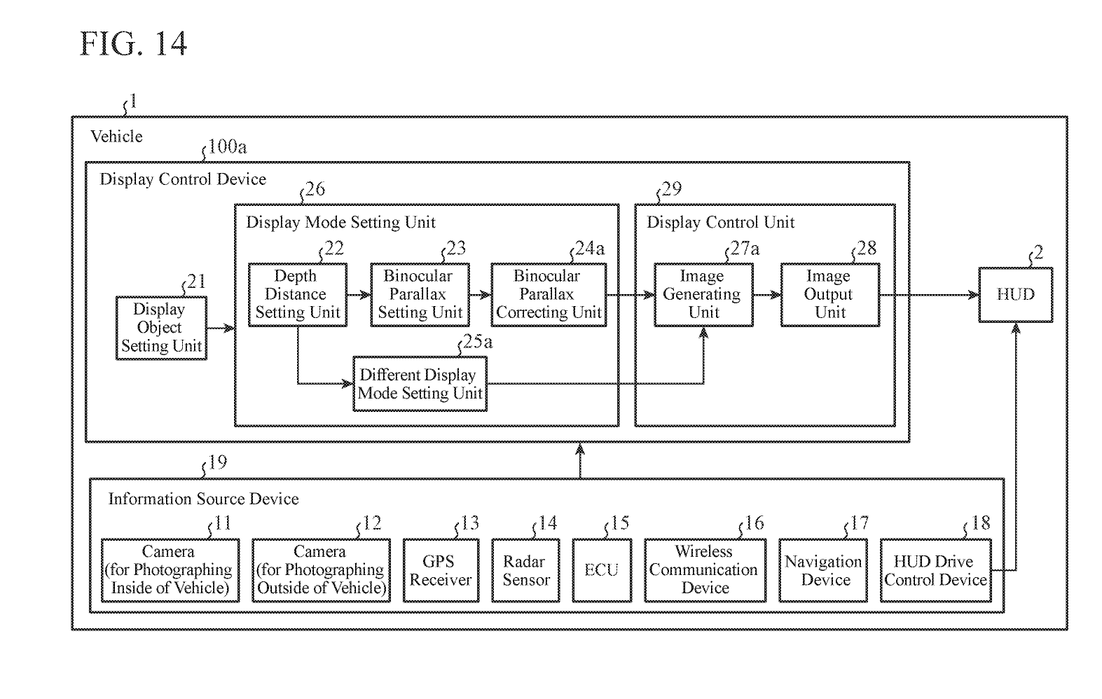

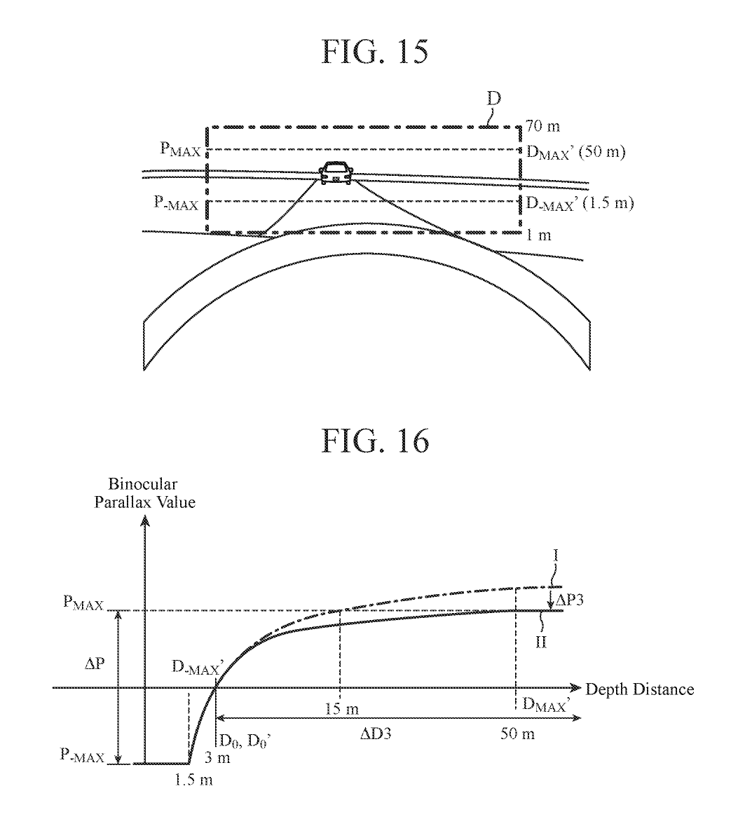

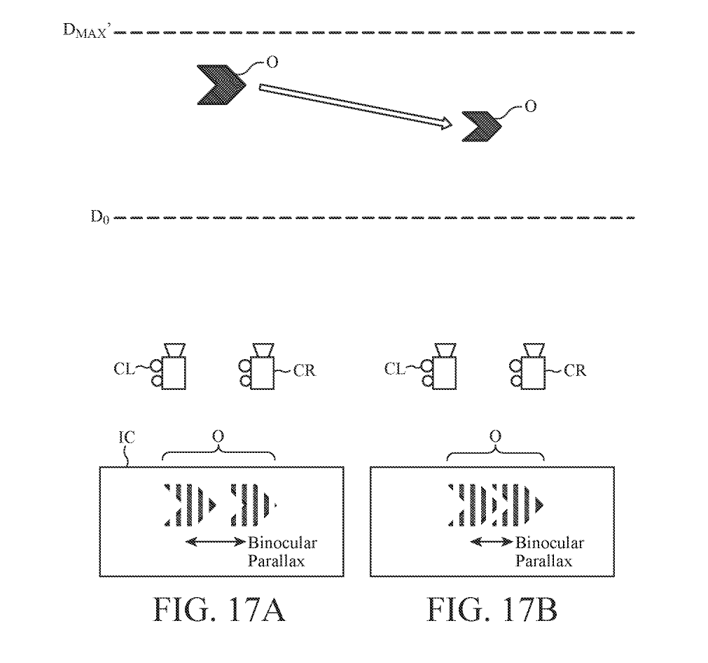

FIG. 14 is a functional block diagram illustrating a main part of a display control device according to the second embodiment of the present invention. FIG. 15 is an explanatory diagram illustrating an example of a display area of an HUD according to the second embodiment of the present invention. FIG. 16 is a characteristic diagram according to the second embodiment of the present invention. FIG. 17A is an explanatory diagram illustrating exemplary correspondence relationship among a depth distance of a display object, a binocular parallax value of the display object, and a stereoscopic vision image including the display object according to the second embodiment of the present invention. FIG. 17B is an explanatory diagram illustrating another exemplary correspondence relationship among a depth distance of a display object, a binocular parallax value of the display object, and a stereoscopic vision image including the display object according to the second embodiment of the present invention. With reference to FIG. 14 to FIG. 17, a display control device 100a of the second embodiment will be described.

Note that in FIG. 14 the same symbol is given to a block similar to that in the functional block diagram of the first embodiment illustrated in FIG. 1, and descriptions thereof will be omitted. In addition, since a hardware configuration of the main part of the display control device 100a is similar to that described with reference to FIG. 7 in the first embodiment, illustration and description thereof are omitted. In addition, since a method of generating a stereoscopic vision image by an image generating unit 27a is similar to that described with reference to FIG. 4 and FIG. 5 in the first embodiment, illustration and description thereof are omitted.

A binocular parallax correcting unit 24a sets a reference range ΔP of the binocular parallax value such that no double image occurs. The image generating unit 27a has a display area setting unit (not illustrated) and sets a rectangle D which is a range within which a stereoscopic vision image is displayed by an HUD 2. In FIG. 15, an exemplary view ahead from a driver's seat of the vehicle 1 through a windshield 4A is illustrated. Here, the windshield type of FIG. 2B will be explained as an example. In the figure, the rectangle D of the alternate long and short dashed line illustrates an example of an area (hereinafter referred to as a “display area”) within which a stereoscopic vision image is displayed by the HUD 2 on the windshield 4A. As described in the first embodiment, the position of the display object in the height direction in the display area of the HUD 2 is set upward as the depth distance of the display object is greater. Moreover, the position of the display object in the height direction in the display area of the HUD 2 is set downward as the depth distance of the display object is smaller. Therefore, in the example of FIG. 15, the depth distance corresponding to the upper side of the rectangle D is substantially the maximum depth distance, and the depth distance corresponding to the lower side portion of the rectangle D is substantially the minimum depth distance. In FIG. 15, the maximum depth distance is set to 50 meters. Here, in order to display a display object at a position of the maximum depth distance of 50 meters, a margin is required on the upper side in the height direction in consideration of the size of the display object. Therefore, in FIG. 15, the upper side of the rectangle D is set to a depth distance of 70 meters considering that a display object may be displayed at the position of the maximum depth distance of 50 meters. This means to be substantially the maximum depth distance. Note that the lower side of the rectangle D is also based on a similar idea and is set to correspond to 1 meter that is substantially the minimum depth distance considering a margin for the minimum depth distance of 1.5 meters.

Here, reasons for setting an area (rectangle D) where a stereoscopic vision image is displayed include downsizing of a space occupied by the mirrors 5 and the optical path which are the optical system. Meanwhile in the case where the HUD 2 is the combiner type illustrated in FIG. 2C, there is a limitation that a stereoscopic vision image cannot be displayed beyond a display range of the combiner 4B.

Note that the display area of the HUD 2 may be different depending on the dimensions of the vehicle 1, the dimensions and performance of the HUD 2, the positions of the user's eyes, etc. The image generating unit 27a may acquire information indicating these contents from an information source device 19 and set the display area using the information.

The binocular parallax correcting unit 24a sets a characteristic line II (hereinafter referred to as the “second characteristic line”) different from the first characteristic line I described in the first embodiment on the basis of the maximum depth distance. The binocular parallax correcting unit 24a corrects a binocular parallax value set by a binocular parallax setting unit 23 using the second characteristic line. Hereinafter, a specific example of a method of setting the second characteristic line II and a method of correcting the binocular parallax value will be described with reference to FIG. 16.

In FIG. 16, I indicates the first characteristic line, and II indicates the second characteristic line. Moreover, ΔP indicates the reference range, P_{MAX} indicates the far-side parallax upper limit value, and P_{-MAX} indicates the near-side parallax upper limit value. Furthermore, D₀ indicates a depth distance at which the binocular parallax value on the first characteristic line I equals zero, and D_{MAX}′ indicates the maximum depth distance, which indicates a depth distance which is substantially the far-side parallax upper limit value. Furthermore, D₀′ indicates a depth distance at which the binocular parallax value on the second characteristic line II equals zero. In the example of FIG. 16, D₀′ and D₀ are set to equivalent values.

As illustrated in FIG. 16, the second characteristic line II is a characteristic line having a logarithmic function shape in which a binocular parallax value at the maximum depth distance D_{MAX}′ is substantially equivalent to the parallax upper limit value P_{MAX}. That is, the second characteristic line II illustrates a characteristic that the binocular parallax value gradually increases as the depth distance increases. In the depth distance range larger than D₀, the binocular parallax value indicated by the second characteristic line II is smaller than the binocular parallax value indicated by the first characteristic line I. Hereinafter, the depth distance range in which the binocular parallax value indicated by the second characteristic line II is smaller than the binocular parallax value indicated by the first characteristic line I is referred to as the “third depth distance range.” In the third depth distance range ΔD3, a differential value between the binocular parallax value indicated by the second characteristic line II and the binocular parallax value indicated by the first characteristic line I gradually increases as the depth distance increases.

That is, correction of a binocular parallax value based on the second characteristic line II reduces the binocular parallax value in the third depth distance range ΔD3. The decrease amount ΔP3 here gradually increases as the depth distance increases.

The image generating unit 27a also sets a display object which is outside the display area (rectangle D) to be hidden. When the display object is set to be hidden, the image generating unit 27a excludes the display object from the stereoscopic vision image.

Note that, in the case where a plurality of display objects is set by a display object setting unit 21, the binocular parallax correcting unit 24a corrects a binocular parallax value for each of the display objects. In this case, the image generating unit 27a further determines, for each of the display objects, whether to hide the display object.

Here, with reference to FIG. 17, a correspondence relationship among a depth distance of a display object, a binocular parallax value of the display object, and a stereoscopic vision image including the display object will be described. FIG. 17A illustrates a state in which the depth distance of a display object O set by the depth distance setting unit 22 has a value between D₀ and D_{MAX}′. FIG. 17A also illustrates a composite image IC when the image generating unit 27 generates a stereoscopic vision image in this state. On the other hand, FIG. 17B illustrates the depth distance of the display object O corresponding to a binocular parallax value corrected by the binocular parallax correcting unit 24a. FIG. 17B also illustrates a composite image IC generated by the image generating unit 27 in this state.

That is, as illustrated in FIG. 17, correction by the binocular parallax correcting unit 24a reduces the binocular parallax value. Here, on the basis of the second characteristic line II illustrated in FIG. 16, the larger the binocular parallax value before correction is, the larger the decrease amount ΔP3, due to the correction, becomes.

The depth distance setting unit 22, the binocular parallax setting unit 23, the binocular parallax correcting unit 24a, and a different display mode setting unit 25a form a display mode setting unit 26. The display object setting unit 21, the display mode setting unit 26, and a display control unit 29 form the main part of the display control device 100a.

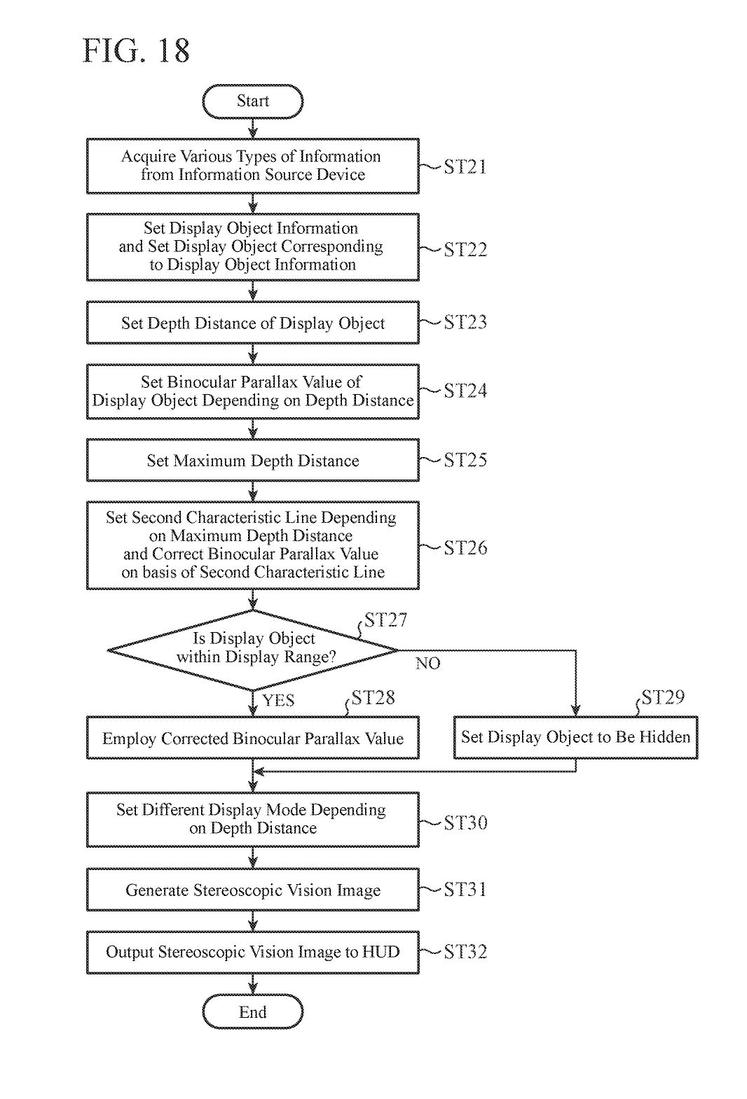

Next, the operation of the display control device 100a will be described with reference to a flowchart of FIG. 18. After initializing various settings and the like in the display control device 100a, the display control device 100a starts processing of step ST21.

First, the display object setting unit 21 executes processing of steps ST21 and ST22, then the depth distance setting unit 22 executes processing of step ST23, and then the binocular parallax setting unit 23 executes processing of step ST24. Since the processing content of steps ST21 to ST24 are similar to those of the steps ST1 to ST4 illustrated in FIG. 8, description thereof are omitted.

Next in step ST25, the binocular parallax correcting unit 24a sets the maximum depth distance D_{MAX}′ corresponding to the far-side parallax upper limit value P_{MAX}. Here, the display area setting unit in the image generating unit 27a sets the display area (rectangle D). The display area (rectangle D) may be set depending on dimensions of the vehicle 1, dimensions and performance of the HUD 2, the positions of the user's eyes, the content of the display object information, etc. by using the information acquired from the information source device 19 or information generated by the display object setting unit 21. Here, the upper side portion of the display area (rectangle D) has a depth distance larger than the maximum depth distance D_{MAX}′. The lower side of the display area (rectangle D) may have a depth distance smaller than the minimum depth distance D_{-MAX}′ or may have a depth distance which is the same as the minimum depth distance D_{-MAX}′.

Next, in step ST26, the binocular parallax correcting unit 24a sets the reference range ΔP and sets the second characteristic line II based on the maximum depth distance D_{MAX}′ and the reference range ΔP. On the basis of the second characteristic line II, the binocular parallax correcting unit 24a corrects the binocular parallax value set in step ST24.

Next in step ST27, the image generating unit 27a determines whether there is a display object in the display area (rectangle D) set in step ST25. If the display object is within the range of the display area (rectangle D) (“YES” in step ST27), the image generating unit 27a sets the display object to be displayed. Furthermore in step ST28, the image generating unit 27a adopts the binocular parallax value corrected by the binocular parallax correcting unit 24a in step ST26.

On the other hand, if the display object is outside the range of the display area (rectangle D), the image generating unit 27a sets the display object to be hidden in step ST29.

Next, the different display mode setting unit 25a executes processing of step ST30. The binocular parallax value obtained from the second characteristic line II is set such that the decrease amount ΔP3 increases as the depth distance increases. Therefore, the different display mode setting unit 25a decreases the size of the display object as the decrease amount ΔP3 increases. Moreover, as the decrease amount ΔP3 increases, the position of the display object is moved upward in the height direction. At least one of the above is to be implemented. That is, the second embodiment differs from the first embodiment in that the size or the position in the height direction of the display object is changed depending on the decrease amount Δ3 even at a depth distance that does not reach the far-side parallax upper limit value.

Next, the image generating unit 27a executes processing of step ST31. Here, in the case where the display object is within the display area, the image generating unit 27a generates a stereoscopic vision image on the basis of the binocular parallax value received from the binocular parallax correcting unit 24a or the corrected binocular parallax value and the display modes of the display object received from the different display mode setting unit 25a. In step ST32, the image output unit 28 outputs the stereoscopic vision image of the display object in the display area to the HUD 2. Note that when the display object has been set to be hidden in step ST29, the image generating unit 27a excludes the display object from the stereoscopic vision image in step ST31.

Next, a specific example of the operation of the display control device 100a will be described based on the above flowchart.

In step ST22, the display object setting unit 21 sets, for example, information indicating a left/right turning point of the vehicle 1 on a travel route to be guided as display object information. The display object setting unit 21 further sets an arrow-shaped stereoscopic object indicating the direction of left/right turn at that point as a display object.

In step ST23, the depth distance setting unit 22 calculates that a distance from the current position of the vehicle 1 to a position of the left/right turning point is 10 meters by using the position information acquired from the GPS receiver 13 and information indicating the position of the left/right turning point acquired from the navigation device 17, etc. The depth distance setting unit 22 sets the depth distance of the display object to a value of 10 meters.

In step ST24, the binocular parallax setting unit 23 sets a binocular parallax value when the depth distance is 10 meters on the first characteristic line I as the binocular parallax value of the display object.

In step ST25, the binocular parallax correcting unit 24a sets the maximum depth distance D_{MAX}′ corresponding to the far-side parallax upper limit value P_{MAX}. Here, the display area setting unit in the image generating unit 27a sets the display area (rectangle D). The display area (rectangle D) may be set depending on dimensions of the vehicle 1, dimensions and performance of the HUD 2, the positions of the user's eyes, the content of the display object information, etc. by using the information acquired from the information source device 19 or information generated by the display object setting unit 21. Here, the binocular parallax correcting unit 24a sets the maximum depth distance D_{MAX}′ to, for example, 50 meters. Furthermore, the display area setting unit in the image generating unit 27a sets the upper side of the display area (rectangle D) to 70 meters and the lower side to 1 meter, for example.

In step ST26, the binocular parallax correcting unit 24a sets the second characteristic line II. For example, the second characteristic line II is a curve having a logarithmic function shape in which a binocular parallax value at a depth distance of 50 meters (D_{MAX}) equals the far-side parallax upper limit value P_{MAX}, a binocular parallax value at a depth distance of 3 meters (D₀′) equals zero, and a binocular parallax value at a depth distance of 1.5 meters (D_{-MAX}′) equals the near-side parallax upper limit value P_{-MAX}. As illustrated in FIG. 16, in the second characteristic line II, the binocular parallax value is gradually decreased by ΔP3 in the third depth distance range ΔD3 as compared with the first characteristic line I.

In step ST27, the image generating unit 27a determines whether there is a display object in the display area (rectangle D) set in step ST25. In the present example, the depth distance of the display object set in step ST23 is 10 meters, whereas the maximum depth distance that can be displayed in the display area (rectangle D) is 50 meters, and the minimum depth distance is 1.5 meters. That is, the display object can be displayed within the range of the display area (rectangle D) (“YES” in step ST27). In step ST28, the image generating unit 27a adopts the binocular parallax value corrected in step ST26.

In step ST30, the different display mode setting unit 25a sets the size and the position in the height direction of the display object depending on the depth distance (10 meters) set in step ST23. As illustrated in FIG. 16, the binocular parallax value in the third depth distance range ΔD3 is set smaller in the second characteristic line II than in the first characteristic line I. That is, according to the second characteristic line II, the stereoscopic image is displayed closer than the desired depth distance of 10 meters. Therefore, the different display mode setting unit 25a reduces the size of the display object and moves the position in the height direction upward, thereby correcting the stereoscopic vision image as if the display object is present at a depth distance of 10 meters. In addition, the different display mode setting unit 25a sets colors, shading, and the like of the display object.

In step ST31, the image generating unit 27a generates a stereoscopic vision image including the display object based on the binocular parallax value corrected in step ST26 and based on the different display modes set in step ST30. In step ST32, the image output unit 28 outputs the stereoscopic vision image generated in step ST31 to the HUD 2.

Next, effects of the display control device 100a will be described. First, the display control device 100a sets the second characteristic line II on the basis of the maximum depth distance D_{MAX}′ and corrects the binocular parallax value on the basis of the second characteristic line II. That is, since the binocular parallax value is gradually corrected over almost the entire third depth distance range ΔD3, a stereoscopic vision image that presents less awkwardness to the user can be provided as compared to the first embodiment in which the correction is made once the far-side parallax upper limit value P_{MAX} is exceeded.

In particular, the display control device 100a can reduce the awkwardness perceived by the user in the case where a plurality of display objects is present as compared to the display control device 100 according to the first embodiment.

For example, it is assumed that the display object setting unit 21 sets a first display object and a second display object, that the depth distance setting unit 22 sets the depth distance of the first display object to 14 meters and the depth distance of the second display object to 30 meters, and that a binocular parallax value when a depth distance on the first characteristic line I is 15 meters is set as the parallax upper limit value P_{MAX}. According to the first embodiment, in this example, the first display object is not subjected to any correction, whereas the second display object is corrected as to the size and the position in the height direction in addition to the binocular parallax value. Therefore, when the first display object not subjected to correction and the second display object subjected to correction are simultaneously displayed, there is a possibility that the user feels awkwardness.

On the other hand, in the correction based on the second characteristic line II illustrated in FIG. 16, setting the third depth distance range ΔD3 leads to correction of the binocular parallax values of both the first display object and the second display object or adjustment of the size or the position in the height direction for each of the display objects. Therefore, the situation where one of the display objects is uncorrected and the other display object is corrected is reduced, and thus a stereoscopic vision image that is unlikely to make the user feel awkwardness can be provided.

Note that the third depth distance range ΔD3 is not limited to the depth distance range larger than D₀ as illustrated in FIG. 16. That is, it is pointless to perform correction using the second characteristic line in an area where the first characteristic line I and the second characteristic line II are substantially the same curve. Therefore, in setting the second characteristic line II, a depth distance range in which the first characteristic line I and the second characteristic line II are substantially different may be set as the third depth distance range ΔD3.

Moreover, the display mode setting unit 26 may include both the binocular parallax correcting unit 24 illustrated in FIG. 1 and the binocular parallax correcting unit 24a illustrated in FIG. 14. Likewise, the display mode setting unit 26 may include both the different display mode setting unit 25 illustrated in FIG. 1 and the different display mode setting unit 25a illustrated in FIG. 14. In the case where a plurality of display objects is set by the display object setting unit 21, correction of the binocular parallax value may be executed, for each of the display objects, by either the binocular parallax correcting unit 24 or the binocular parallax correcting unit 24a depending on the content of display object information corresponding to each of the display objects, correspondence relationship between the display objects, etc. The same applies to the different display mode setting units 25 and 25a.

In addition, the display control device 100a can adopt various modifications similar to those described in the first embodiment. For example, the image generating unit 27a may generate a stereoscopic vision image including a comparative display object. Furthermore, each of the functional blocks of the display control device 100a may be implemented by any computer or any processing circuit as long as the computer or the processing circuit is mounted on the vehicle 1, brought into the vehicle 1, or capable of freely communicating with the vehicle 1. The display control device 100a can also be used for a moving body different from the vehicle 1 and can also be used for a display device different from the HUD 2.

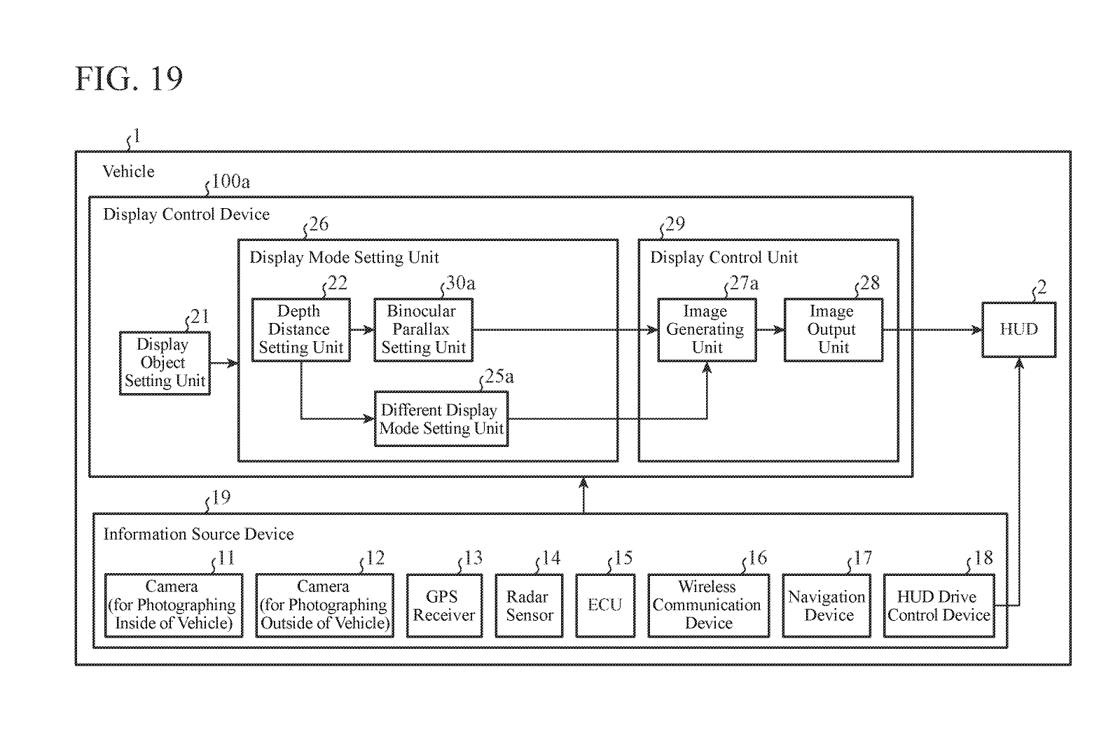

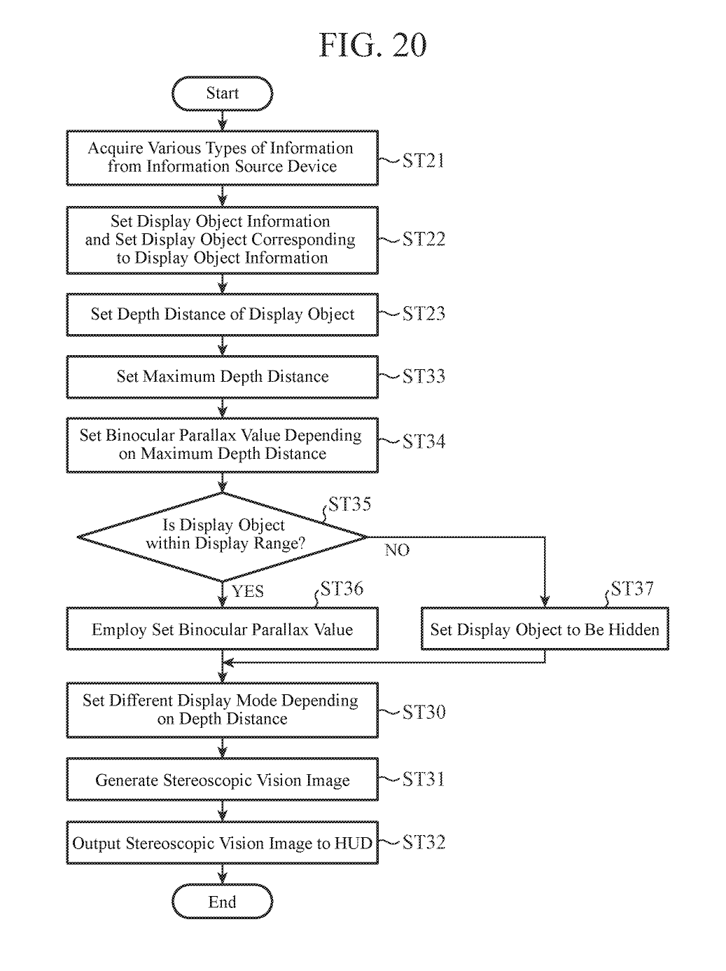

Furthermore, when setting a binocular parallax value of a display object, the display mode setting unit 26 may set the binocular parallax value by one-step processing of setting the binocular parallax value on the basis of the second characteristic line II (step ST34) instead of setting the binocular parallax value by the two-step processing of first setting a binocular parallax value on the basis of the first characteristic line I (step ST24) and then correcting the binocular parallax value on the basis of the second characteristic line II (step ST26). That is, the function of the binocular parallax setting unit and the function of the binocular parallax correcting unit may be integrated into one. A functional block diagram in this case is illustrated in FIG. 19, and a flowchart is illustrated in FIG. 20.

Subsequent to the setting of the depth distance by a depth distance setting unit 22 (step ST23), a binocular parallax setting unit 30a sets the maximum depth distance D_{MAX}′ corresponding to the far-side parallax upper limit value P_{MAX} in step ST33. In addition, a display area setting unit in an image generating unit 27a sets the display area (rectangle D). Next, in step ST34, the binocular parallax setting unit 30a sets the second characteristic line II illustrated in FIG. 16 on the basis of the maximum depth distance D_{MAX}′. The binocular parallax setting unit 30a sets a binocular parallax value of a display object on the basis of the second characteristic line II. That is, the binocular parallax setting unit 30a forms the binocular parallax setting unit and the binocular parallax correcting unit.

Next in step ST35, the image generating unit 27a determines whether the display object can be displayed in the display area (rectangle D) set in step ST33. If the display object can be displayed in the display area (rectangle D) (“YES” in step ST35), in step ST36, the image generating unit 27a adopts the binocular parallax value set in step ST34.

On the other hand, if the display object is outside the set display area (rectangle D) (“NO” in step ST35), the image generating unit 27a sets the display object to be hidden in step ST37.

Next, the different display mode setting unit 25a executes processing of step ST30, the image generating unit 27a executes processing of step ST31, and an image output unit 28 executes processing of step ST32. Note that when the display object has been set to be hidden in step ST37, the image generating unit 27a excludes the display object from the stereoscopic vision image in step ST31.

As described above, the display control device 100a of the second embodiment is used for a display device for a moving body, in which the binocular parallax setting unit 23 calculates the binocular parallax value of the display object on the basis of the first characteristic line I in which a binocular parallax value increases as the value moves away from the position (D₀) where the binocular parallax value equals zero, and the binocular parallax correcting unit 24a corrects the binocular parallax value on the basis of the second characteristic line II which increases toward the far-side parallax upper limit value P_{MAX} as the depth distance extends farther. This enables provision of a stereoscopic vision image which is unlikely to make the user feel awkwardness Moreover, the binocular parallax setting unit and the binocular parallax correcting unit can be configured by the binocular parallax setting unit 30a.

Furthermore, the display control unit 29 includes the display area setting unit for setting the display area (rectangle D) in which the area, beyond the depth distance D_{MAX}′ corresponding to the upper limit P_{MAX} provided on the far side of the binocular parallax value, is also included and displayed and sets the display object to be hidden when the display position of the display object deviates from the display area (rectangle D). As a result, the display object can be displayed in an appropriate display area.

### Third Embodiment

In the first embodiment and the second embodiment, the description has been made on the premise that an overlooking angle of the user does not change from a reference overlooking angle that is preset. In a third embodiment the case where an overlooking angle of a user changes is considered to allow a display object to be viewed at the same position as that viewed from a reference overlooking angle by adjustment of the optical system or adjustment of display modes depending on the overlooking angle of the user. Note that the third embodiment can be applied to the first embodiment or the second embodiment.

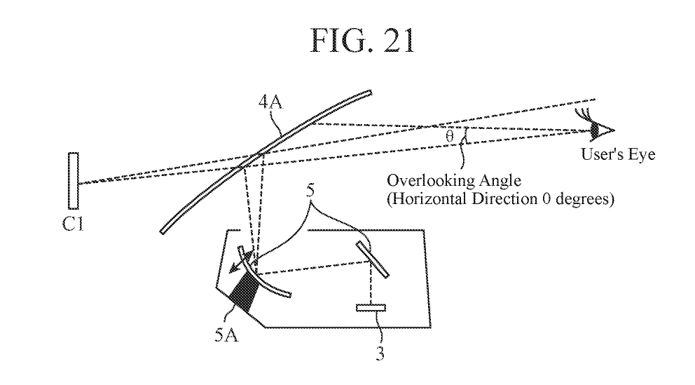

FIG. 21 is an explanatory diagram illustrating a relationship between the overlooking angle and a display device. Here, an overlooking angle refers to an angle θ at which a user overlooks a display device with respect to the horizontal direction of 0 degrees. The main reasons why the overlooking angle changes is the positional relationship between the height of the user's eyes and a stereoscopic vision image projected on the semitransparent mirror 4 for projection. The height of the eyes changes depending on the posture of the user or the sitting height of each user. The position of the stereoscopic vision image varies depending on the angle of the angle adjusting device 5A. FIG. 21 is a diagram illustrating that the overlooking angle of a virtual image C1 is determined by the positional relationship between the height of the user's eyes and the stereoscopic vision image.

Detailed description will be given below using the drawings.

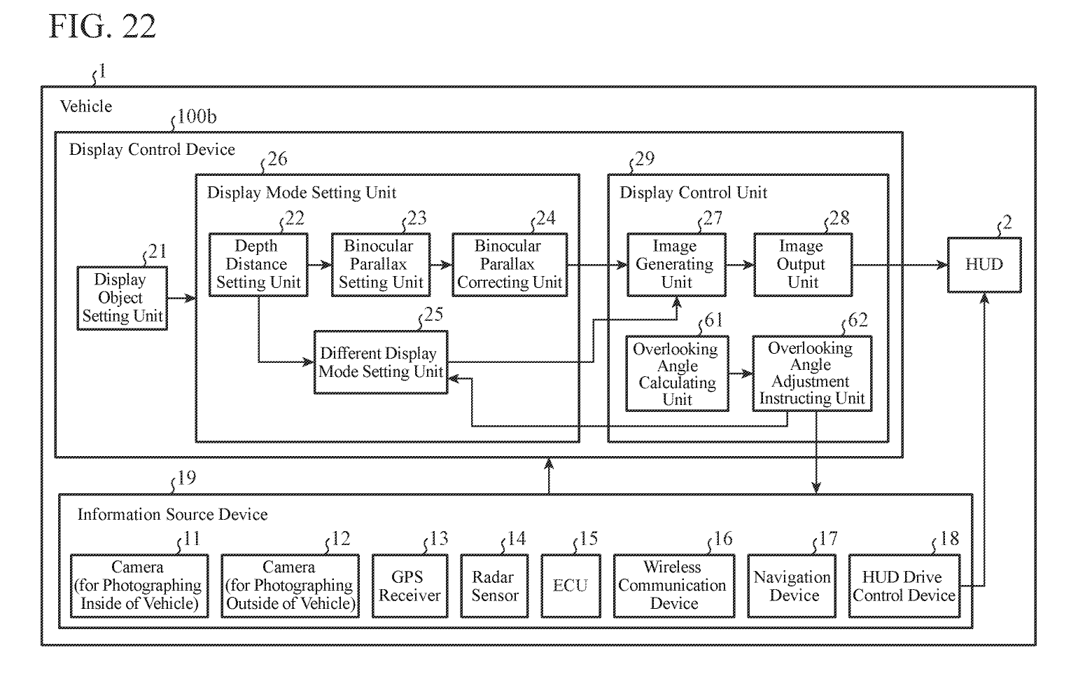

FIG. 22 is a functional block diagram illustrating a main part of a display control device 100b in the case where the third embodiment is applied to the first embodiment. An overlooking angle calculating unit 61 acquires information of the height of the user's eyes and information of the position of the stereoscopic vision image projected on the semitransparent mirror 4 to calculate the overlooking angle of the user. The information of the height of the user's eyes may be obtained on the basis of an image of the user obtained from a camera 11. The height of the user's eyes or the position of the stereoscopic vision image may be acquired from calculation results by an information source device 19 or may be calculated by the overlooking angle calculating unit 61 on the basis of information obtained from the information source device 19.

The overlooking angle calculated by the overlooking angle calculating unit 61 is provided to an overlooking angle adjustment instructing unit 62. The overlooking angle adjustment instructing unit 62 has, for example, an overlooking angle serving as a reference and instructs adjustment of the optical system or instructs the different display mode setting unit 25 to adjust display modes on the basis of a difference between the reference overlooking angle and the overlooking angle calculated by the overlooking angle calculating unit 61. Here, the optical system refers to the angles of the mirrors 5, for example. In addition, adjustment of display modes refers to adjustment of display modes such as the shape, the position, the size, and the like of a display object in a stereoscopic vision image displayed on the display 3 that is performed by the different display mode setting unit 25. Here, the adjustment of display modes means to achieve display modes that keeps a view unchanged from that viewed from the reference overlooking angle even when the overlooking angle changes.

An image generating unit 27, an image output unit 28, the overlooking angle calculating unit 61, and the overlooking angle adjustment instructing unit 62 form a display control unit 29. A display object setting unit 21, a display mode setting unit 26, and the display control unit 29 form the main part of the display control device 100b.

First, the case where the angles of the mirrors 5, as the optical system, are adjusted will be described.

The overlooking angle adjustment instructing unit 62 acquires angle information of the mirrors 5 from the information source device 19 and adjusts the angles of the mirrors 5 such that an overlooking angle of the user matches the reference overlooking angle. In order to adjust the angles of the mirrors 5, the overlooking angle adjustment instructing unit 62 outputs an instruction signal for adjusting the angles of the mirrors 5 to an HUD drive control device 18. In response to this instruction signal, the HUD drive control device 18 drives the angle adjusting device 5A to adjust the mirrors 5 at desired angles.

As a result, even when the height of the user's eyes changes, the reference overlooking angle can be maintained. By maintaining at the reference overlooking angle, even when the position of the user's eyes changes, the display object can be displayed at the same position as that from the reference overlooking angle.

Next, the case where the shape, the position, the size, or the like of the display object in the stereoscopic vision image on the display 3 is adjusted as adjustment of display modes will be described.

On the basis of the difference between the reference overlooking angle and the overlooking angle calculated by the overlooking angle calculating unit 61, the overlooking angle adjustment instructing unit 62 determines in which direction and how much the display object is displaced and displayed to calculate the amount of the shift. Note that the amount of the shift is affected by the position of the user's eyes and the angles of the mirrors 5. Therefore, the overlooking angle adjustment instructing unit 62 acquires the position of the user's eyes and the angles of the mirrors 5 from the information source device 19 for use in calculation. This amount of the shift is provided to the different display mode setting unit 25. When setting display modes of the display object, the different display mode setting unit 25 adjusts display modes such as the shape, the position, the size, etc. of the display object in consideration of the amount of the shift.

As a result, even when the height of the user's eyes changes, the display object can be displayed at the same position as that from the reference overlooking angle.

Note that, in the above description, the example in which both adjustment of the angles of the mirrors 5 and image processing of the display 3 are included has been described; however, it is not always necessary to include both, and it suffices to adopt either one of the two.

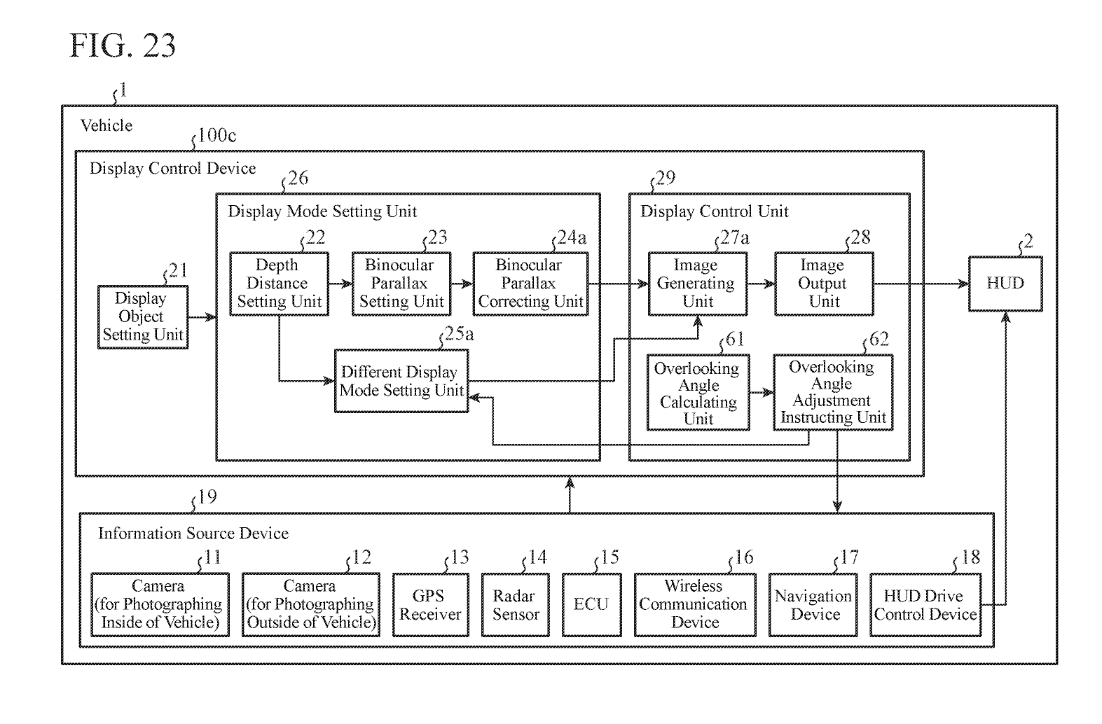

FIG. 23 is a functional block diagram illustrating a main part of a display control device 100c in the case where the third embodiment is applied to the second embodiment. The display control device 100c of FIG. 23 is basically similar to the display control device 100b of FIG. 22 in that a display object is displayed such that the display object is viewed in the same manner as viewed from the reference overlooking angle even when the overlooking angle changes.

That is, an image generating unit 27a, an image output unit 28, an overlooking angle calculating unit 61, and an overlooking angle adjustment instructing unit 62 form a display control unit 29. A display object setting unit 21, a display mode setting unit 26, and the display control unit 29 form the main part of the display control device 100c.

In the second embodiment, the display area setting unit in the image generating unit 27a may set the display area (rectangle D). When an overlooking angle of a user changes, not only the position of the display object but also the display area (rectangle D) changes.

For example in the case where the height of the user's eyes is high, an overlooking angle is wide. In this case, the display area (rectangle D) is set downward in the height direction as viewed from the user. Contrarily, in the case where the height of the user's eyes is low, an overlooking angle is narrow. In this case, the display area (rectangle D) is set upward in the height direction as viewed from the user.

Specifically, it has been described that, in the display area (rectangle D) in FIG. 15, the upper side is set to 70 meters. Here, in the case where the height of the user's eyes is high, an overlooking angle is wide. In this case, the display area (rectangle D) is set downward in the height direction as viewed from the user. That is, for example, in the display area (rectangle D) the upper side is set at 60 meters. Therefore, the overlooking angle adjustment instructing unit 62 instructs an HUD drive control device 18 to adjust the angles in order to change the angles of the mirrors 5.

That is, the angles of the mirrors 5 are adjusted by the HUD drive control device 18 such that the position of the display area (rectangle D) with respect to the position of the windshield 4A as viewed from the user does not change. For example, the HUD drive control device 18 adjusts the angles of the mirrors 5 such that the upper side of the display area (rectangle D) is at 70 meters on the basis of the instruction signal from the overlooking angle adjustment instructing unit 62 even when the overlooking angle is larger than the reference value.

As a result, even when the overlooking angle of the user changes, a relative position of the upper side of the display area (rectangle D) with respect to the windshield 4A does not change.

Note that, in order to cope with a change in the height of the eyes due to a change in users, it is only required that the adjustment of the third embodiment be performed at the time of getting in the vehicle. In addition, in order to cope with a change in the height of the eyes due to a change in the posture of the user, it is only required that, for example, the user be monitored by the camera 11 and that the adjustment be performed when there is a change in the posture.

Moreover, the rectangle D has been described as an example of the display area in the second and third embodiments; however, a display area is not limited to a rectangle as long as the display area specifies an area. For example, a belt-like shape that specifies only an upper side and a lower side may be employed. Alternatively, only an upper side may be specified without specifying a lower side.

As described above, the display control devices 100b and 100c of the third embodiment are used for a display device for a moving body and each include the overlooking angle calculating unit 61 for calculating the overlooking angle θ of the user to the moving body. The display control unit 29 adjusts the optical system or display modes of the display object on the basis of a difference between the reference overlooking angle and the calculated overlooking angle. As a result, even when the overlooking angle of the user changes, the display object can be displayed at the same position as that from the reference overlooking angle.

Moreover, the display control unit 29 adjusts display modes of the display object such that the display object viewed from the calculated overlooking angle is viewed at the same position as that of the display object viewed from the reference overlooking angle. As a result, even when the overlooking angle of the user changes, the display object can be displayed at the same position as that from the reference overlooking angle.

Furthermore, the display control unit 29 includes a display area setting unit for setting a display area (rectangle D) in which an area, beyond the depth distance D_{MAX}′ corresponding to the upper limit P_{MAX} provided on a far side of a binocular parallax value, is also included and displayed and adjusts the optical system such that an upper side of the display area viewed from the calculated overlooking angle matches an upper side of the display area viewed from the reference overlooking angle. As a result, even when the overlooking angle changes, the display object can be displayed within the display area as viewed from the user.

The display control unit 29 further outputs an instruction signal for adjusting the angles of the optical system such that the display area viewed from the calculated overlooking angle corresponds to the display area viewed from the reference overlooking angle. This allows the display area as viewed by the user to remain unchanged even when an overlooking angle changes.

Note that, within the scope of the present invention, the present invention may include a flexible combination of the respective embodiments, a modification of any component of the respective embodiments, or an omission of any component in the respective embodiments.

### INDUSTRIAL APPLICABILITY

A display control device and a display control method of the present invention can be used for control of an HUD, an HMD, or the like for displaying a stereoscopic vision image on a moving body.

### REFERENCE SIGNS LIST

1: Vehicle, 2: HUD, 3: Display, 4: Semitransparent mirror, 4A: Windshield, 4B: Combiner, 5: Mirror, 5A: Angle adjusting device, 6: Server, 7: Image generating unit, 11: Camera, 12: Camera, 13: GPS receiver, 14: Radar sensor, 15: ECU, 16: Wireless communication device, 17: Navigation device, 18: HUD drive control device, 19: Information source device, 21: Display object setting unit, 22: Depth distance setting unit, 23: Binocular parallax setting unit, 24, 24a: Binocular parallax correcting unit, 25, 25a: Different display mode setting unit, 26: Display mode setting unit, 27, 27a: Image generating unit, 28: Image output unit, 29: Display control unit, 30, 30a: Binocular parallax setting unit, 31: Communication device, 41: Memory, 42: Processor, 43: Processing circuit, 61: Overlooking angle calculating unit, 62: Overlooking angle adjustment instructing unit, 100, 100a, 100b, 100c: Display control device

1.-21. (canceled)

22. A display control device used for a display device for a moving body, the display control device comprising:
a processor; and
a memory storing instructions which, when executed by the processor, causes the processor to perform processes of:
setting a depth distance of a display object corresponding to display object information;
setting a binocular parallax value of the display object depending on the set depth distance;
correcting the set binocular parallax value;
changing a display mode of the display object on a basis of a corrected amount of the binocular parallax value; and
outputting, to the display device, a stereoscopic vision image including the display object on the basis of either the set binocular parallax value or the corrected binocular parallax value,
wherein the correction lowers the binocular parallax value in at least a part of a depth distance range, and
the processor changes at least a size of the display object depending on the corrected amount of the binocular parallax value.

23. The display control device according to claim 22,
wherein the stereoscopic vision image includes a plurality of the display objects,
the processor sets a depth distance for each of the display objects,
sets the binocular parallax value for each of the display objects,
corrects the binocular parallax value for each of the display objects, and
changes at least a size of each of the display objects depending on the corrected amount of the binocular parallax value of each of the display objects.

24. The display control device according to claim 22,
wherein the processor corrects the binocular parallax value such that an amount of decrease in the binocular parallax value increases as the depth distance extends farther, and
the processor reduces the size of the display object in a case where the corrected amount is large, as compared with a case where the corrected amount is small.

25. The display control device according to claim 24, wherein the processor moves the display object upward with respect to a front landscape or lighten a color of the display object in a case where the corrected amount of the binocular parallax value is large, as compared with case where the corrected amount is small.

26. The display control device according to claim 22,
wherein the processor corrects the binocular parallax value such that an amount of decrease in the binocular parallax value increases as the depth distance approaches closer to a near side, and
the processor increases the size of the display object in a case where the corrected amount is large, as compared with a case where the corrected amount is small.

27. The display control device according to claim 26, wherein the processor moves the display object downward with respect to a front landscape or deepen a color of the display object in a case where the corrected amount of the binocular parallax value is large, as compared with a case where the corrected amount is small.

28. The display control device according to claim 22, wherein the processor generates a comparative display object which is displayed together with the display object to express the depth distance of the display object.

29. The display control device according to claim 28, wherein the comparative display object expresses at least one of density, a shadow, and overlap.

30. The display control device according to claim 22,
wherein the processor calculates the binocular parallax value of the display object on a basis of a first characteristic line in which the binocular parallax value increases as the binocular parallax value moves away from a position where the binocular parallax value equals zero, and
the processor corrects the binocular parallax value by setting an upper limit at least on a far side of the first characteristic line.

31. The display control device according to claim 30, wherein the processor corrects the binocular parallax value by setting an upper limit on a near side of the first characteristic line.

32. The display control device according to claim 22,
wherein the processor calculates the binocular parallax value of the display object on a basis of a first characteristic line in which the binocular parallax value increases as the binocular parallax value moves away from a position where the binocular parallax value equals zero, and
the processor corrects the binocular parallax value on a basis of a second characteristic line which increases toward a far-side parallax upper limit value as the depth distance extends farther.

33. The display control device according to claim 32, wherein the processor corrects the binocular parallax value by setting an upper limit at least on a near side of the first characteristic line.

34. The display control device according to claim 22,
wherein the processes further comprise setting a display area in which an area, which is beyond the depth distance corresponding to an upper limit provided on a far side of the binocular parallax value, is also included and displayed, and
the processor sets the display object to be hidden when a display position of the display object deviates from the display area.

35. The display control device according to claim 22,
wherein the processes further comprise calculating an overlooking angle of a user to the moving body,
wherein the processor adjusts an optical system or a display mode of the display object on a basis of a difference between a reference overlooking angle and the calculated overlooking angle.

36. The display control device according to claim 35, wherein the processor adjusts the display mode of the display object such that the display object viewed from the calculated overlooking angle is viewed at a same position as that of the display object viewed from the reference overlooking angle.

37. The display control device according to claim 35,
wherein the processes further comprise setting a display area in which an area, which is beyond the depth distance corresponding to an upper limit provided on a far side of the binocular parallax value, is also included and displayed, and
the processor adjusts the optical system such that an upper side of a display area viewed from the calculated overlooking angle matches an upper side of the display area viewed from the reference overlooking angle.

38. The display control device according to claim 37,
wherein the processor outputs an instruction signal for adjusting an angle of the optical system such that the display area viewed from the calculated overlooking angle corresponds to the display area viewed from the reference overlooking angle.

39. The display control device according to claim 22, wherein the processor outputs the stereoscopic vision image to the display device so as to be superimposed on a landscape viewed from the moving body.

40. The display control device according to claim 39,
wherein the moving body is a vehicle or a pedestrian, and
the display device comprises a head up display mounted on the vehicle or a head mounted display mounted on a head of a user of the vehicle of the pedestrian.

41. A display control method used for a display device for a moving body, the display control method comprising:
setting a depth distance of a display object corresponding to display object information;
setting a binocular parallax value of the display object depending on the set depth distance;
correcting the set binocular parallax value;
changing a display mode of the display object on a basis of a corrected amount of the binocular parallax value; and
outputting to the display device, a stereoscopic vision image including the display object on a basis of either the set binocular parallax value or the corrected binocular parallax value,
lowering the binocular parallax value in at least a part of a depth distance range in the correcting step, and
changing at least a size of the display object depending on the corrected amount of the binocular parallax value.
